(19) United States
(12) Patent Application Publication
(10) Pub. No.: US 2025/0227754 A1
(43) Pub. Date: Jul. 10, 2025

(54) TERMINAL DEVICE AND COMMUNICATION METHOD

(71) Applicant: Sony Group Corporation, Tokyo (JP)

(72) Inventor: Kazuyuki SHIMEZAWA, Tokyo (JP)

(73) Assignee: Sony Group Corporation, Tokyo (JP)

(21) Appl. No.: 18/853,732

(22) PCT Filed: Apr. 3, 2023
(86) PCT No.: PCT/JP2023/013836

§ 371 Date: Oct. 3, 2024

(30) Foreign Application Priority Data
Apr. 13, 2022 (JP) 2022-066576

(51) Int. Cl. H04W 74/0808; H04W 16/14; H04W 92/18

(52) U.S. Cl. CPC H04W 74/0808; H04W 16/14; H04W 92/18

(57) ABSTRACT

A terminal device includes a transceiver and circuitry that cooperate to perform sidelink (SL) sensing relating to SL communication and Look Before Talk (LBT) sensing relating to communication in a shared spectrum. The circuitry selects a transmission resource for SL communication with the another terminal device by using any one of a first to third channel allocation protocols. The circuitry transmits SL data by using the selected transmission resource. The first channel allocation protocol performs the LBT sensing based on a result of the SL sensing. The second channel allocation protocol performs the SL sensing based on a result of the LBT sensing. The third method performs the SL sensing and the LBT sensing independent of one another.

### TECHNICAL FIELD

The present disclosure relates to a terminal device and a communication method.

### BACKGROUND ART

In the 3rd generation partnership project (3GPP (Registered Trademark)), device-to-device (D2D) communication for performing direct communication between terminals (UEs) is standardized as “sidelink communication” by each of 4G long term evolution (LTE) and 5G new radio (NR). In the sidelink communication, vehicle-to-everything (V2X) communication is one of main use cases. As the V2X communication, vehicle-to-vehicle (V2V), vehicle-to-infrastructure (V2I), vehicle-to-pedestrian (V2P), and vehicle-to-network (V2N) are assumed.

Particularly, in sidelink communication in 5G NR, platooning, advanced driving, an extended sensor, and remote driving are assumed as advanced V2X communication. In the sidelink communication in 5G NR, standards are formulated so as to realize at least one of high-speed and large-capacity communication and low-delay and high-re-liability communication as compared with sidelink communication in 4G LTE.

As a use case of the sidelink communication, in addition to V2X communication in the related art, extension and application to commercial use (commercial use case) used in houses, offices, factories, and the like are expected.

When commercial use of the sidelink communication is assumed, higher speed communication and cost reduction are required as compared with the V2X communication in the related art.

As one solution thereof, an unlicensed band (an unlicensed spectrum, or a shared spectrum) that does not require a license for use of a predetermined frequency band has been proposed to be used and is expected to be standardized in NR Release-18.

### CITATION LIST

### Non Patent Literature

NPL 1: “TS22.186, 3rd Generation Partnership Project; Technical Specification Group Services and System Aspects; Enhancement of 3GPP support for V2X scenarios; Stage 1 (Release 16)”, [online], [Searched on Mar. 8, 2022], Internet<https://www.3gpp.org/ftp//Specs/archive/22_series/22.186/22186-g20.zip>NPL 2: “RP-213678, “New WID on NR sidelink evolution,” OPPO, LG Electronics, 3GPP TSG RAN Meeting #94e, Electronic Meeting, Dec. 6-17, 2021″, [online], [Searched on Mar. 8, 2022], Internet<https://www.3gpp.org/ftp/tsg_ran/TSG_RAN/TSGR_94e/Docs/RP-213678.zi p>

### SUMMARY OF INVENTION

### Technical Problem

As described above, sidelink communication using an unlicensed band (shared spectrum) has been studied. Alternately, the sidelink communication in the related art is assumed to be communication in a licensed band. In the sidelink communication as well, sensing is performed prior to the communication, but the corresponding sensing is performed on the premise of sensing in the licensed band, and sensing of sidelink communication in the unlicensed band is not considered.

Therefore, it is difficult to apply the sidelink communication in the licensed band in the related art to the sidelink communication in the unlicensed band without change.

Therefore, in the present disclosure, there is provided a mechanism capable of realizing the sidelink communication using the unlicensed band.

Note that the above problem or object is merely one of a plurality of problems or objects that may be solved or achieved by the plurality of embodiments disclosed in the present specification.

### Solution to Problem

A terminal device of the present disclosure includes a communication unit and a control unit. The communication unit performs sidelink communication with another terminal device on a shared spectrum. The control unit performs sidelink sensing relating to the sidelink communication and listen before talk (LBT) sensing relating to communication in the shared spectrum via the communication unit. The control unit selects a transmission resource for sidelink communication with the another terminal device by using any one of a first method, a second method, and a third method. In this context, “xxxxx method” refers to a particular channel allocation protocol. For example, the first method is a first channel allocation protocol in which sidelink sensing is performed prior (in time) to LBT. The second method is a second channel allocation protocol in which LBT is performed prior (in time) to sidelink sensing. The third method is a third channel allocation protocol in which both sidelink sensing and LBT are performed, but they are performed independent in time with respect to one another. The control unit transmits one or more items of sidelink data by using the selected transmission resource via the communication unit. The first method is a method of selecting the transmission resource by performing the LBT sensing based on a result of the sidelink sensing. The second method is a method of selecting the transmission resource by performing the sidelink sensing based on a result of the LBT sensing. The third method is a method of selecting the transmission resource by individually performing the sidelink sensing and the LBT sensing.

### BRIEF DESCRIPTION OF DRAWINGS

FIG. 1 is a diagram illustrating an outline of a wireless communication system according to an embodiment of the present disclosure.

FIG. 2 is a diagram illustrating an example of SL sensing according to the embodiment of the present disclosure.

FIG. 3 is a diagram illustrating another example of the SL sensing according to the embodiment of the present disclosure.

FIG. 4 is a diagram illustrating LBT Category 1.

FIG. 5 is a diagram illustrating LBT Category 2.

FIG. 6 is a diagram illustrating LBT Categories 3 and 4.

FIG. 7 is a diagram illustrating an outline of a frame based equipment (FBE).

FIG. 8 is a diagram illustrating a configuration example of the base station according to the embodiment of the present disclosure.

FIG. 9 is a diagram illustrating a configuration example of a terminal device according to the embodiment of the present disclosure.

FIG. 10 is a diagram illustrating an example of a first COT response mode according to the embodiment of the present disclosure.

FIG. 11 is a diagram illustrating an example of a second COT response mode according to the embodiment of the present disclosure.

FIG. 12 is a diagram illustrating an example of a first COT sharing mode according to the embodiment of the present disclosure.

FIG. 13 is a diagram illustrating an example of a second COT sharing mode according to the embodiment of the present disclosure.

FIG. 14 is a diagram illustrating an outline of a sensing method according to the embodiment of the present disclosure.

FIG. 15 is a diagram illustrating an example of a first sensing method according to the embodiment of the present disclosure.

FIG. 16 is a diagram illustrating an example of a second sensing method according to the embodiment of the present disclosure.

FIG. 17 is a diagram illustrating another example of the second sensing method according to the embodiment of the present disclosure.

FIG. 18 is a diagram illustrating another example of the second sensing method according to the embodiment of the present disclosure.

FIG. 19 is a diagram illustrating an example of a third sensing method according to the embodiment of the present disclosure.

FIG. 20 is a diagram illustrating an example of the third sensing method according to the embodiment of the present disclosure.

FIG. 21 is a diagram illustrating an example of an SL-U sensing method based on CPS according to the embodiment of the present disclosure.

FIG. 22 is a diagram illustrating another example of the SL-U sensing method based on the CPS according to the embodiment of the present disclosure.

FIG. 23 is a diagram illustrating an example of a first COT sharing method according to the embodiment of the present disclosure.

FIG. 24 is a diagram illustrating an example of a second COT sharing method according to the embodiment of the present disclosure.

### DESCRIPTION OF EMBODIMENTS

Hereinafter, embodiments of the present disclosure are described in detail with reference to the accompanying drawings. Note that, in the present specification and the drawings, a component having substantially the same functional configuration is denoted by the same reference numeral, and overlapping description is omitted.

Furthermore, in the present specification and the drawings, similar components according to the embodiment may be distinguished by adding different alphabets or numbers after the same reference numerals. However, when it is not necessary to particularly distinguish respective similar components, only the same reference numeral is assigned.

One or a plurality of embodiments (including examples, modifications, and application examples) described below can each be implemented independently. Meanwhile, at least some of the plurality of embodiments described below may be appropriately combined with at least some of other embodiments. The plurality of embodiments may include novel features different from each other. Therefore, the plurality of embodiments may contribute to solving different objects or problems and can exhibit different effects.

### <<1. Introduction>>

### <1.1. Outline of Wireless Communication System>

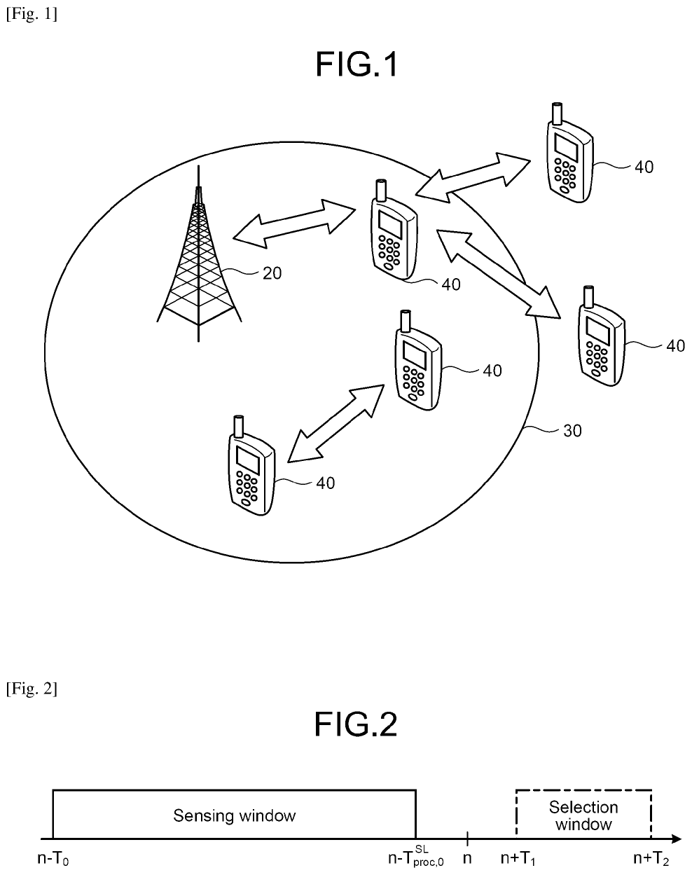

FIG. 1 is a diagram illustrating an outline of a wireless communication system according to an embodiment of the present disclosure.

The wireless communication system of FIG. 1 includes at least a base station 20 and a terminal device 40. The base station 20 may accommodate the plurality of terminal devices 40. The base station 20 may be connected to another base station 20 (not illustrated) by means of an X2 interface.

The base station 20 may be connected to an evolved packet core (EPC) (not illustrated) by means of an S1 interface. The base station 20 may be connected to a mobility management entity (MME) (not illustrated) by means of an S1-MME interface. The base station 20 may be connected to a serving gateway (S-GW) (not illustrated) by means of an S1-U interface.

The S1 interface supports a many-to-many connection between at least one of the MME and the S-GW and the base station 20. Furthermore, in the present embodiment, the base station 20 and the terminal device 40 support at least one of LTE and NR, respectively.

In the wireless communication system illustrated in FIG. 1, sidelink communication is performed in an unlicensed band. First, an outline of the sidelink communication is described.

### <1.2. Sidelink Communication>

### <1.2.1. Outline of Sidelink Communication>

In the example of FIG. 1, two or more terminal devices 40 exist inside a cell 30 configured by the base station 20. The terminal device 40 may perform sidelink communication. Otherwise, when at least one terminal device 40 of the two or more terminal devices 40 exists inside the cell 30, and the remaining terminal devices 40 exist outside the cell 30, the terminal device 40 inside the cell 30 and the terminal device 40 outside the cell 30 may perform sidelink communication. In addition, the terminal device 40 existing inside the cell 30 may perform relay between the base station 20 and the terminal device 40 existing outside the cell 30 by communicating with the base station 20.

Note that the existence of the terminal device 40 inside the cell 30 may be said to be a state in which the quality of the downlink signal from the base station 20 received by the terminal device 40 is a predetermined standard or higher. In addition, the existence of the terminal device 40 inside the cell 30 can be said to be a state in which a predetermined downlink channel from the base station 20 received by the terminal device 40 may be decoded with a predetermined probability or more. In other words, the existence of the terminal device 40 outside the cell 30 may be said to be a state in which the quality of the downlink signal from the base station 20 received by the terminal device 40 is the predetermined standard or less. In addition, the existence of the terminal device 40 outside the cell 30 may be said to be a state in which a predetermined downlink channel from the base station 20 received by the terminal device 40 cannot be decoded with predetermined probability or more.

Hereinafter, in the present embodiment, when two terminal devices 40 that perform transmission and reception by the sidelink communication are distinguished, one is referred to as a first terminal device 40_1, and the other is referred to as a second terminal device 40_2.

### <1.2.2. Details of Sidelink Communication>

The sidelink communication is direct communication between the first terminal device 40_1 and the second terminal device 40_2. In the sidelink communication, a resource pool is configured in the terminal device 40. The resource pool is a candidate of time and frequency resources used for transmission and reception of the sidelink communication. The terminal device 40 selects a resource for transmission and reception of the sidelink from the resource pool and performs sidelink communication. Since the sidelink communication can be performed using an uplink resource (an uplink subframe and an uplink component carrier), the resource pool may be configured in the uplink subframe or the uplink component carrier. Furthermore, the sidelink communication may be performed using a dedicated resource.

The sidelink physical channel includes a physical sidelink control channel (PSCCH), a physical sidelink shared channel (PSSCH), a physical sidelink feedback channel (PSFCH), and the like.

The PSCCH is used to transmit sidelink control information (SCI). Mapping of information bits of the sidelink control information is defined as an SCI format. The sidelink control information includes a sidelink grant. The sidelink grant is used for scheduling PSSCH.

PSSCH is used to transmit sidelink data (sidelink shared channel: SL-SCH). Note that PSSCH may be used to transmit control information (for example, MAC/RRC signaling) of an upper layer such as a MAC layer and a PDCP layer.

The PSFCH is used to reply a HARQ response (ACK/NACK) to the decoding result of the PSSCH or the SL-SCH to the terminal device 40 on the transmission side.

The resource pool is configured from the base station 20 to the terminal device 40 by the SIB or the dedicated RRC message. Alternatively, the resource pool is configured by information regarding the resource pool pre-configured in the terminal device 40. Note that, in the following description, all or a part of the information configured by the base station 20 may be pre-configured in the terminal device 40. The resource pool of a time is indicated by period information, offset information, and subframe bitmap information. The frequency resource pool is indicated by a start position of a resource block, an end position of a resource block, and the number of consecutive resource blocks.

### [Sidelink Resource Pool]

In the sidelink communication, a resource pool (sidelink resource pool) is configured as a resource used for transmission of the PSSCH and reception of the PSSCH. In the frequency axis, the resource pool is configured with one or a plurality of consecutive subchannels. A subchannel is configured with one or a plurality of consecutive PRBs. The number of subchannels and a size of the subchannel are configured by an upper layer parameter.

A slot configured as the resource pool is indicated by a bitmap. Each bit of the bitmap corresponds to the slot that can be configured as the resource pool of the sidelink communication. For example, when a value of a bit indicates one, the corresponding slot is configured as a resource pool. When a value of a bit indicates zero, the corresponding slot is not configured as a resource pool. The length of a bitmap is configured by an upper layer.

A slot including an S-SS/PSBCH block (S-SSB) is not configured as the resource pool. Further, a slot that does not semi-statically include a predetermined number of uplink symbols is not configured as a resource pool. In addition, the reserved slot is not configured as the resource pool. A sidelink-synchronization signal (S-SS) is a signal used for synchronization in sidelink communication. A physical sidelink broadcast channel (PSBCH) is a channel used for transmitting broadcast information (system information or the like) in sidelink communication.

Note that a device for configuring the resource pool may be other than the base station 20. Examples of the device other than the base station 20 include the repre-sentative terminal device 40 (a primary terminal device and a master terminal device) and the like.

### <1.2.3. Sensing Method in Sidelink Communication>

When the sidelink resource allocation mode 2 is configured, the terminal device 40 selects a sidelink resource from the configured resource pool according to a predetermined procedure. The predetermined procedure includes predetermined sensing. For example, the terminal device 40 performs predetermined sensing defined in advance and selects a sidelink resource based on a result of the corresponding sensing.

In this manner, the sensing performed by the terminal device 40 to select the sidelink resource is referred to as sidelink sensing (hereinafter, also simply referred to as sidelink (SL) sensing) regarding sidelink communication. Details of the SL sensing are described in Section 8.1.4 of TS38.214.

As the SL sensing, the terminal device 40 on the transmission side (hereinafter, also referred to as TxUE40T) receives PSCCH transmitted from another terminal device 40 in the resource pool. The TxUE40T grasps the resource allocation status (usage status) of the resource pool based on the SCI transmitted through the received PSCCH.

Further, the TxUE40T measures reference signal received power (RSRP) of the resource (resource to which PSSCH is allocated) scheduled by the SCI transmitted through the received PSCCH, excludes the resource from resources for resource selection if the RSRP is a predetermined value or more, and selects a resource for sidelink (SL) communication from the remaining resources.

In the PSRP measurement, PSCCH-PSRP and PSSCH-RSRP are defined, and either of the PSCCH-PSRP and the PSSCH-RSRP is configured by RRC signaling. The PSCCH-PSRP and the PSSCH-RSRP are measured with demodulation reference signals (DMRS) of the PSCCH and resources of the DMRS of the PSSCH, respectively.

Note that the sensing is performed in units of predetermined frequency and time resources used in the sidelink communication. The predetermined frequency resource is a subchannel and is configured with one or more resource blocks. The predetermined time resource is a slot.

### (SL Sensing When Traffic Is Periodically Generated)

FIG. 2 is a diagram illustrating an example of SL sensing according to the embodiment of the present disclosure. The SL sensing method illustrated in FIG. 2 is particularly suitable (used) when transmission data of the sidelink communication performed by another terminal device 40 is periodically generated traffic (periodic transmission).

This method is also referred to as full sensing. In the full sensing, the TxUE40T configures a selection window (resource selection period) configured with a period from n+T₁ to n+T₂ when there is a trigger for resource selection at a time n. In addition, the TxUE40T configures a sensing window (sensing period) configured with a period from n-T₀ to n-T_{proc,0}^{SL} when there is a trigger for resource selection at the time n. Since this sensing window is a time earlier than the time n, the TxUE40T performs sensing in advance.

In this method, periodic transmission is assumed as described above. Therefore, a list of periodicity of possible sidelink (SL) transmission is configured for the TxUE40T by RRC signaling. That is, the TxUE40T can estimate a resource usage status in the future from a resource usage status in the past based on this periodicity.

Note that the “RRC signaling” described above or below means that one or a plurality of RRC parameters (information elements: IE) are included in a predetermined RRC message (for example, RRC reconfiguration or RRC setup) and transmitted.

When the RRC message is transmitted on the downlink, the RRC message is transmitted from the base station 20 (for example, gNB) to the terminal device 40. When the RRC message is transmitted on the uplink, the RRC message is transmitted from the terminal device 40 to the base station 20. When the RRC message is transmitted on the sidelink, the RRC message is transmitted from the TxUE40T to the terminal device 40 on the receiving side (hereinafter, also referred to as RXUE40R).

Details of each parameter are as follows.

T₀={100, 1100 [ms]} is a parameter indicating a start time point of the sensing window and is configured by the RRC signaling (RRC IE: sl-Sensing Window). Note that the unit of this parameter is a millisecond, and the unit of the other parameters is a slot.

T₁ is a value of 0 to T_{proc,1}^{SL} and is selected by the TxUE40T. T_{proc,1}^{SL} is a parameter corresponding to the processing time of the TxUE40T and is defined according to a subcarrier spacing (SCS). For example, T_{proc,1}^{SL} is T_{proc,1}^{SL}=3 for 15 kHz, 5 for 30 kHz, 9 for 60 kHz, and 17 for 120 kHz.

T₂ is a value of T₂ₘᵢₙ to the remaining time (remaining packet delay budget) of an allowable delay of the corresponding transmission data and is selected by the TxUE40T. T₂ₘᵢₙ is configured by the RRC signaling (RRC IE: sl-Selection WindowList) and a possible value is {1, 5, 10, 20}.

T_{proc,0}^{SL}=1 for 15 kHz, 1 for 30 kHz, 2 for 60 kHz, and 4 for 120 kHz is a parameter corresponding to the processing time of the TxUE40T and defined according to the subcarrier spacing.

### (Procedure of Sidelink Sensing)

In the TxUE40T, a specific operation of the TxUE40T in full sensing when there is a resource selection trigger at the time n is as follows. Note that the following “configuration” is a configuration performed inside the TxUE40T.

(A1) The TxUE40T defines (configures) the selection window. More specifically, a candidate single-slot resource R_{x,y} for transmission is defined as a set of contiguous subchannels L_{subCH} with subchannels x+j in a slot t′_{y}^{SL}. Here, j represents the number of contiguous subchannels L_{subCH}. The TxUE40T assumes that any set of the contiguous subchannels L_{subCH} also corresponds to any one of the following three cases:
a) any set of the contiguous subchannels L_{subCH} included in the corresponding resource pool in time intervals [n+T₁ and n+T₂] corresponds to one candidate single slot resource for the UE (terminal device 40) that performs full sensing;
b) for a UE that performs periodic-based partial sensing, any set of the contiguous subchannels L_{subCH} included in the corresponding resource pool in a set of a plurality of candidate slots Y in time intervals [n+T₁ and n+T₂] corresponds to one candidate single slot resource for the UE (Y satisfies Y≥Yₘᵢₙ (RRC IE: minNumCandidateSlots) and is selected by the UE); or
c) for a UE that performs contiguous partial sensing in case of a resource reservation interval Prsvp_TX=0, any set of the contiguous subchannels L_{subCH} included in the corresponding resource pool in the set of a plurality of candidate slots Y′ in the time intervals [n+T₁ and n+T₂] corresponds to one candidate single slot resource for the UE (Y′ satisfies Y′>Y′min and is selected by the UE).

Note that the sum of the plurality of candidate single slots is represented by Mₜₒₜₐₗ.

(A2) The TxUE40T defines (configures) a sensing window. As described above, the sensing window is defined by a range of a plurality of slots represented by [n−T₀ and T_{proc,0}^{SL}) (in the case of full sensing). Further, the TxUE40T monitors (senses) the plurality of slots corresponding to the resource pool in the sensing window. However, since the TxUE40T has the half duplex restriction, the TxUE40T may not monitor (sense) the transmitted slot. When the UE performs periodic-based partial sensing, the UE monitors the plurality of slots that satisfies t_{y-kxP_reserve}^{SL}. Here, t_{y}^{SL} is one slot among the plurality of candidate slots selected above. In addition, the monitoring (sensing) is performed based on a decoding process of the PSCCH from other UEs in these slots and PSRP measurement.

(A3) The TxUE40T configures an RSRP threshold Th (pᵢ, pⱼ). The RSRP threshold is determined based on a parameter (RRC IE: sl-Thres-RSRP-List) notified by the base station 20 and is an independent value according to the priority of the transmission data. More specifically, a value corresponding to the RSRP threshold indicated by the i-th field in sl-Thres-RSRP-List is configured (set) as Th (pᵢ, pⱼ). Here, i=p; +(pⱼ−1)*8.

(A4) The TxUE40T initializes all the candidates (the set of all the candidate single-slot resources) of the resource in the selection window as a set SA. Note that the resource candidate is a predetermined frequency and time resource unit used in the sidelink communication. In addition, in the following step, the TxUE40T excludes the resource corresponding to the predetermined condition from the set SA.

(A5) The TxUE40T excludes resources (any candidate single-slot resources R_{x,y}) satisfying all of the following conditions from the set SA.
a) A slot t′SL that is not sensed in step A2.
b) A slot that can be used for sidelink transmission based on a list of periodicity of sidelink transmission and decoded PSSCH (an SCI format 1-A that is received in the slot t′ SL and includes a ‘Resource reservation period’ field).

If the number of candidate single-slot resources R_{x,y} remaining in the set S_{A} is smaller than X Mtotal, the set S_{A} returns to step A4 and is initialized.

(A6) The TxUE40T excludes resources (any candidate single-slot resources R_{x,y}) satisfying all of the following conditions from the set SA.
a) A resource indicated by an SCI transmitted by the PSSCH from another UE. More specifically, the TxUE40T receives the SCI format 1-A in the slot t′SL, and the ‘Resource reservation period’ field (only if present) and the ‘Priority’ field in the received SCI format 1-A indicate P_{rsvp_RX} and prio_{RX}, respectively.
b) By the RSRP measurement, a resource of which a measured value is higher than the RSRP threshold Th (prio_{RX} or prio_{TX}) configured in step A3.
c) A slot that can be used for sidelink transmission based on the list of the peri-odicities of the sidelink transmission and the decoded PSSCH.

(A7) When the number of resources remaining in the set S_{A} is smaller than the predetermined value X Mₜₒₜₐₗ obtained based on the parameter configured by the RRC signaling, the TxUE40T increases a value Th (pᵢ or pⱼ) of the RSRP threshold by a predetermined value (3 dB) and performs again from step A4.

(A8) The TxUE40T randomly selects resources for sidelink transmission from the resources remaining in the set SA.

By performing the above procedures (A1) to (A8), the TxUE40T performs SL sensing.

In the full sensing described above, by using the sensing result in the past at the time point when the transmission data is generated, the TxUE40T determines the sidelink resource to which the corresponding transmission data is transmitted. Therefore, the TxUE40T always performs a sensing process.

For example, when the TxUE40T is a device driven by a small battery such as a smartphone, it is not preferable to always perform the sensing process from the viewpoint of power consumption. Therefore, partial sensing in which a part of the sensing window is reduced in order to reduce power consumption is standardized.

In the partial sensing, the TxUE40T basically performs resource selection from the sensed resources and does not perform resource selection from the other resources. This sensing method is also referred to as periodic based partial sensing (PBPS).

### (SL Sensing When Traffic Is Aperiodically Generated)

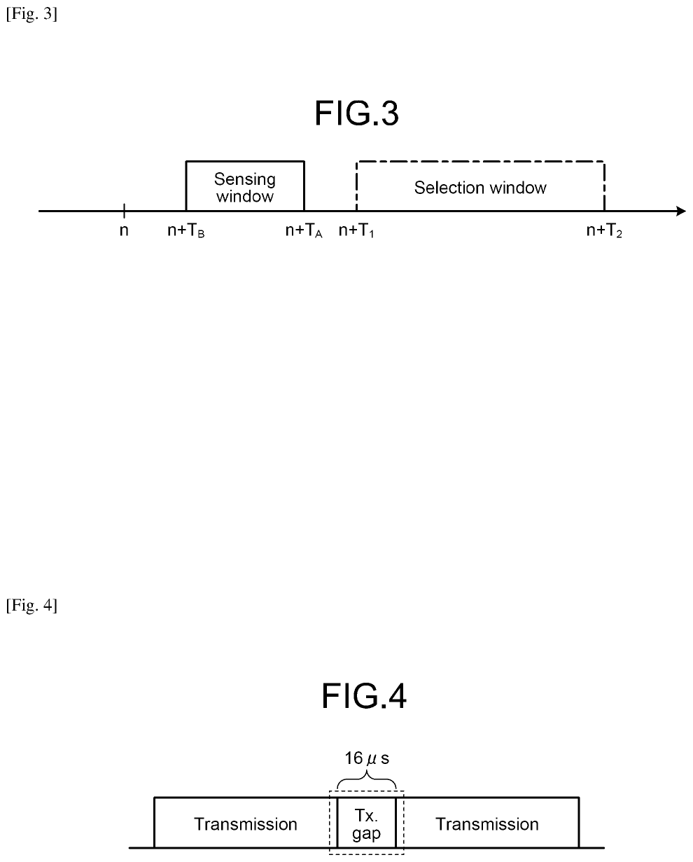

FIG. 3 is a diagram illustrating another example of the SL sensing according to the embodiment of the present disclosure. The SL sensing method illustrated in FIG. 3 is particularly suitable (used) when transmission data of the sidelink communication performed by another terminal device 40 is aperiodically generated traffic (aperiodic transmission).

This method is also referred to as contiguous partial sensing (CPS). In the CPS, the TxUE40T basically defines a sensing window immediately before the selection window and performs sensing. In the CPS, the sensing window is configured in a period from n+T_{B} to n+T_{A}. T_{A} and T_{B} each may be a positive value, a negative value, or zero depending on the use case or status. For example, T_{B} is a value determined based on the processing time and is T_{proc,0}^{SL}+T_{proc,1}^{SL}. For example, T_{A} is configured by RRC signaling.

### <1.3. NR (NR-U: NR Unlicensed) in Unlicensed Band>

In a Uu link of 5G NR (downlink communication and uplink communication between the base station 20 and the terminal device 40), a communication method in an unlicensed band is standardized. Hereinafter, a technology related to the NR-U is described.

### (Channel Access of Unlicensed Channel)

In the unlicensed channel, a wireless device (the base station 20 or the terminal device 40) performs channel access (channel access, medium access, or listen before talk) before transmission of a signal. Note that the unlicensed channel is a unit of a frequency band in which channel access is performed. The channel may also be expressed as a carrier, a frequency carrier, a component carrier, a cell, a frequency band, a listen before talk (LBT) band, or the like. The unlicensed channel may correspond to a subchannel in sidelink.

In the channel access, the wireless device performs channel power measurement (carrier sensing, sensing, or channel clear assessment: CCA) and compares the measured channel power value with an energy detection threshold.

If the measured channel power value is lower than the energy detection threshold, the channel is determined to be clear. If the measured channel power value is higher than the energy detection threshold, the channel is determined to be busy. If the channel is determined to be clear in all sensing slots, the wireless device can acquire a transmission right (TxOP, a transmission opportunity, COT, or a channel occupancy time) for the channel and transmit a signal.

Further, the acquired channel may be used for transmission of another wireless device (the base station 20 or the terminal device 40). In this case, a grant is sent from the wireless device (one of the base station 20 and the terminal device 40) that acquires the channel to the other wireless device (the other of the base station 20 and the terminal device 40).

A wireless device (one of the base station 20 and the terminal device 40) that acquires the channel is referred to as an initiating device. A wireless device (the other of the base station 20 and the terminal device 40) using the channel acquired by the other wireless device (one of the base station 20 and the terminal device 40) is referred to as a responding device.

Note that, in 3GPP (registered trademark), four types of LBT categories are defined as carrier sensing systems. In the channel access, LBT corresponding to any one of the following LBT categories is performed.
LBT Category 1: No LBT
LBT Category 2: LBT that does not perform random backoff
LBT Category 3: LBT that performs random backoff with a contention window with a fixed size
LBT Category 4: LBT that performs random backoff with a contention window with a variable size

Here, each LBT category is described with reference to FIGS. 4 to 6.

FIG. 4 is a diagram illustrating LBT Category 1. As illustrated in FIG. 4, in LBT Category 1 (Cat1 LBT), the wireless device performs communication without performing LBT. In the example of FIG. 4, the wireless device performs transmission at a transmission interval of 16 microseconds. LBT Category 1 is also referred to as Type 2C channel access or Type 3 channel access.

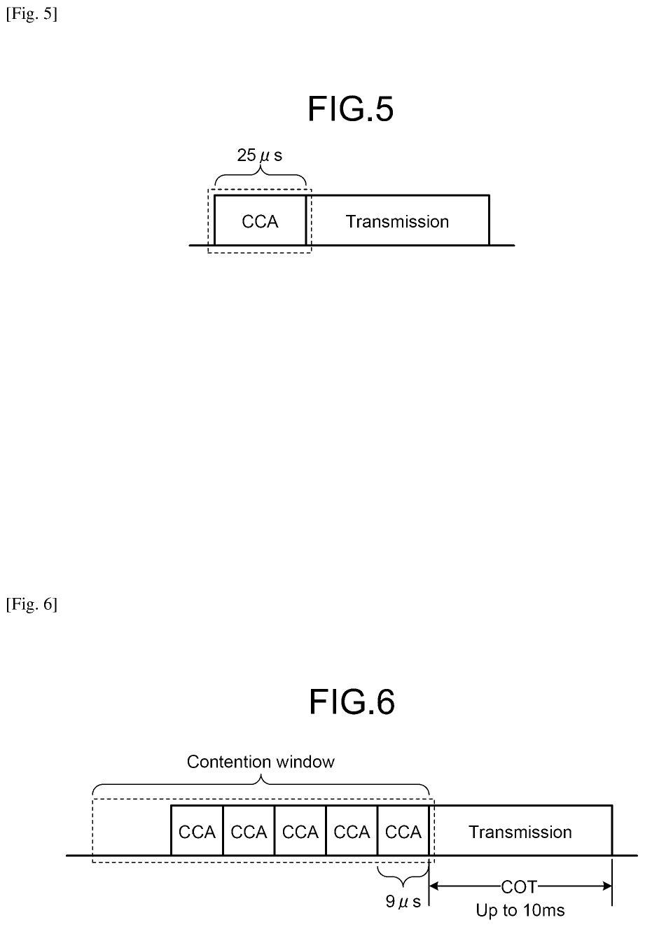

FIG. 5 is a diagram illustrating LBT Category 2. As illustrated in FIG. 5, in LBT Category 2 (Cat2 LBT), the wireless device performs communication by performing LBT without performing random backoff. In the example of FIG. 5, the wireless device performs CCA on one sensing slot and transmits a signal when it is determined that the channel is clear.

The length of one sensing slot (CCA) is 25 microseconds or 16 microseconds. In the example of FIG. 5, the wireless device performs transmission at a transmission interval of 25 microseconds. LBT Category 2 in which the time length of the CCA is 25 microseconds is also referred to as Type 2A channel access. LBT Category 2 in which the time length of the CCA is 16 microseconds is also referred to as Type 2B channel access.

FIG. 6 is a diagram illustrating LBT Categories 3 and 4. As illustrated in FIG. 6, in LBT Categories 3 and 4 (Cat3 LBT and Cat4 LBT), the wireless device performs CCA a predetermined number of times in a contention window (CW) and transmits a signal when it is determined that a channel is clear. That is, the wireless device performs CCA in a predetermined number of times of sensing slots and transmits a signal when it is determined that the channels are clear in all the sensing slots. In FIG. 6, a case where the length of one sensing slot is 9 microseconds, and the CCA is performed five times is illustrated.

Note that LBT Category 3 and LBT Category 4 are different from each other in whether the size of the contention window is fixed or variable. Alternatively, LBT Category 3 and LBT Category 4 are different from each other in whether the contention window size is adjusted.

LBT Category 3 performs random backoff with the contention window with a fixed size. LBT Category 3 is also referred to as Type 1A channel access. LBT Category 3 may be used at a predetermined frequency (for example, a frequency defined by Frequency Range 2-2 (FR2-2) including the 60 GHz band) and may not be used at other frequencies.

LBT Category 4 performs random backoff with the contention window with a variable size. LBT Category 4 is also referred to as Type 1 channel access.

### (Channel Access Procedure of Unlicensed Channel)

A channel access (channel access, medium access, or listen before talk) procedure is performed to access an unlicensed channel for transmission in the base station 20 or the terminal device 40.

In a channel access procedure defined as a load-based equipment (LBE, dynamic channel access, and channel access procedure in dynamic channel occupancy), a channel is sensed once or a plurality of times. Based on the sensing result, whether the channel is idle (idle, unoccupied, available, or enable) or busy (busy, occupied, unavailable, or disable) is determined (vacancy determination). In the channel sensing, the power of the channel during predetermined latency is sensed.

Examples of the latency of the channel access procedure include first latency (slot), second latency, a third latency (defer period), and fourth latency.

A slot is a unit of latency of the base station 20 and the terminal device 40 in the channel access procedure. The slot is defined, for example, by 9 microseconds.

At second latency, one slot is inserted at the head. The second latency is defined, for example, by 16 microseconds.

The defer period is configured with the second latency and a plurality of consecutive slots following the second latency. The number of consecutive slots following the second latency is determined based on a priority class (channel access priority class) used to satisfy QoS.

Fourth latency is configured with the second latency and one slot following the second latency. The fourth latency is defined, for example, by 25 microseconds.

The base station 20 or the terminal device 40 senses a predetermined channel during a period of a predetermined slot. When power detected by the base station 20 or the terminal device 40 for at least 4 microseconds within the predetermined slot period is smaller than a predetermined energy detection threshold, the predetermined slot is considered to be idle. Alternatively, when the power is larger than the predetermined energy detection threshold, the predetermined slot is considered to be busy.

The channel access procedures include a first channel access procedure, a second channel access procedure, and a third channel access procedure. The first channel access procedure is performed using a plurality of slots and a defer period. The second channel access procedure is performed by using one item of the second latency or the fourth latency. In the third channel access procedure, channel sensing is not performed.

A parameter relating to a channel access is determined based on a priority class. Examples of the parameter relating to a channel access include a minimum contention window, a maximum contention window, a maximum channel occupancy time, and a possible value of the contention window.

The priority class is determined by a value of a quality of service (QOS) class identifier (QCI) or a 5G QoS identifier (5Q1) that processes QoS. Table 1 shows a cor-respondence table between a priority class and a parameter relating to channel access, Table 2 shows an example of mapping between a priority class and QCI, and Table 3 shows an example of mapping between a priority class and 5QI.

TABLE 1
Example of Correspondence Table Between Priority
Class and Parameter Relating to Channel Access

| Channel | | | | Maximum | | Possible |
|---|---|---|---|---|---|---|
| Access | | Minimum | Maximum | Channel | | Value of |
| Priority | | Contention | Contention | Occupancy | | Contention |
| Class | | Window | Window | Time | | Window |
| (p) | mₚ | CW_{min, p} | CW_{max, p} | T_{mcot, p} | | CWₚ |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, |

127, 255, 511,
1023}

TABLE 2
Example of Mapping Between Priority Class and QCI

| Channel Access Priority | |
|---|---|
| Class (p) | QCI |
| 1 | 1, 3, 5, 65, 66, 69, 70 |
| 2 | 2, 7 |
| 3 | 4, 6, 8, 9 |
| 4 | Other than Above |

TABLE 3
Example of Mapping Between Priority Class and 5QI

| Channel Access Priority | |
|---|---|
| Class (p) | 5QI |
| 1 | 1, 3, 5, 65, 66, 69, 70, 79, 80, 82, |
| | 83, 84, 85 |
| 2 | 2, 7, 71 |
| 3 | 4, 6, 8, 9, 72, 73, 74, 76 |
| 4 | — |

### (Details of First Channel Access Procedure)

The first channel access procedure is classified into LBT Category 3 or LBT Category 4. In the present embodiment, the first channel access procedure is also referred to as a Type 1 channel access procedure and Type 1 channel access.

In the first channel access procedure, the following procedure is performed.

(B0) Channel sensing is performed during the defer period. If the channel is idle in a slot within the defer period, the process proceeds to step (B1), and if not, the process proceeds to step (B6).

(B1) An initial value of a counter is acquired. A possible value of the initial value of the counter is an integer between 0 and the contention window CW. The initial value of the counter is randomly determined according to a uniform distribution. The initial value of the counter is set to a counter N, and the process proceeds to step (B2).

(B2) When the counter N is larger than 0, and it is selected to subtract the counter N, 1 is subtracted from the counter N. Thereafter, the process proceeds to step (B3).

(B3) A period of the slot is added, and the counter stands by. In addition, a channel is sensed in the additional slot. If the additional slot is idle, the process proceeds to step (B4), and if not, the process proceeds to step (B5).

(B4) If the counter N is zero, this procedure stops. If not, the process proceeds to step (B2).

(B5) The defer period is added, and the counter stands by. Further, the channel is sensed until it is detected to be busy in any one slot included in the additional defer period, or all slots included in the additional defer period is detected to be idle. Thereafter, the process proceeds to step (B6).

(B6) If the channel is sensed to be idle in all of the slots included in that additional defer period, the process proceeds to step (B4), and if not, the process proceeds to step (B5).

After step (B4) in the above procedure stops, transmission including data such as the PDSCH and the PUSCH is performed in the channel.

Note that, after step (B4) in the above procedure stops, transmission may not be performed in the channel. In this case, thereafter, when the channel is idle in all of the slot and the defer period immediately before the transmission, the transmission may be performed without performing the above procedure. Alternatively, when the channel is not idle in any of the slot and the defer period, after the channel is sensed to be idle in all of the slots in the additional defer period, the procedure proceeds to step (B1).

### (Details of Second Channel Access Procedure)

The second channel access procedure (a Type 2 channel access procedure or Type 2 channel access) includes a Type 2A channel access procedure, a Type 2B channel access procedure, and a Type 2C channel access procedure.

The Type 2A channel access procedure and the Type 2B channel access procedure are classified into LBT Category 2. In the Type 2A channel access procedure, the fourth latency is used. In the Type 2B channel access procedure, the second latency is used.

In the Type 2A channel access procedure and the Type 2B channel access procedure, transmission may be performed immediately after the channel is considered to be idle as a result of sensing of at least the second latency or the fourth latency. Alternatively, transmission is not performed, when it is considered that the channel is not idle as a result of sensing of at least the second latency or the fourth latency. The second channel access procedure is applied when the transmission interval is 16 microseconds or 25 microseconds.

The Type 2C channel access procedure is classified into LBT Category 1. In the Type 2C channel access procedure, the transmission interval is within 16 microseconds, and channel sensing during the interval is not performed (unnecessary). However, in the Type 2C channel access procedure, a transmittable time is limited to 584 microseconds in maximum. In addition, the Type 2C channel access procedure can be applied in Frequency Range 1 (FR1).

### (Details of Third Channel Access Procedure)

The third channel access procedure (Type 3 channel access procedure) is not classified into LBT categories described above. In the Type 3 channel access procedure, the channel is not sensed before transmission. Though there are no lim-itations on the transmission timing and transmittable time as in the Type 2C channel access procedure, the Type 3 channel access procedure is applied in Frequency Range 2 (FR2) or FR2-2 and cannot be applied in FR1.

Note that the performance of the third channel access procedure (Type 3 channel access procedure) may be restricted or prohibited based on regulations of the country or area where the present embodiment is performed. Whether the Type 3 channel access procedure can be performed is determined based on control information transmitted from the base station 20 or information pre-configured in a terminal.

[Contention Window Adaptation Procedure]

In LBT Category 4, a contention window adaptation procedure is performed.

The contention window CW used in the first channel access procedure is determined based on the contention window adaptation procedure.

The value of the contention window CW is stored for each priority class. In addition, the contention window CW takes a value between the minimum contention window and the maximum contention window. The minimum contention window and the maximum contention window are determined based on the priority class.

The adjustment of the value of the contention window CW is performed before step (B1) of the first channel access procedure. If a proportion of NACKs is higher than a threshold in a HARQ response corresponding to a shared channel of a reference HARQ process in at least a reference subframe (reference slot or reference interval) in a contention window adaptation procedure, the value of the contention window CW is increased. If not, the value of the contention window CW is configured to the minimum contention window.

The value of the contention window CW is increased, for example, based on the following equation: CW=2 (CW+1)−1.

The reference interval is defined as from the head of the occupied channel to the end of the first slot including at least one unicast PDSCH or to the end of the first transmission burst including at least one unicast PDSCH.

For example, 90% is configured as the threshold.

### (Details of Channel Access Procedure in Downlink)

In the unlicensed channel, when downlink transmission including the PDSCH, the PDCCH, and/or the EPDCCH is performed, the base station 20 accesses the channel based on the first channel access procedure and performs the downlink transmission.

Alternatively, in the unlicensed channel, when downlink transmission including the DRS but not including PDSCH is performed, the base station 20 accesses the channel based on the second channel access procedure and performs the downlink transmission. Note that the period of the downlink transmission is preferably shorter than 1 millisecond.

Also, in FR2-2, downlink transmission can be performed based on the third channel access procedure in addition to the first channel access procedure and the second channel access procedure.

### (Details of Channel Access Procedure in Uplink)

In the unlicensed channel, when it is indicated to perform the first channel access procedure with the uplink grant for scheduling the PUSCH, the terminal device 40 performs the first channel access procedure before the uplink transmission including the PUSCH.

In addition, when it is indicated to perform the second channel access procedure with the uplink grant for scheduling the PUSCH, the terminal device 40 performs the second channel access procedure before the uplink transmission including the PUSCH.

Further, with respect to the uplink transmission including the SRS but not including the PUSCH, the terminal device 40 performs the second channel access procedure before the uplink transmission.

Further, it is assumed that the end of the uplink transmission indicated by the uplink grant is within the uplink duration (UL duration). In this case, regardless of the procedure type indicated by the uplink grant, the terminal device 40 performs the second channel access procedure before the uplink transmission.

In addition, when the uplink transmission continues including the fourth latency after the completion of the downlink transmission from the base station 20, the terminal device 40 performs the second channel access procedure before the uplink transmission.

Also, in FR2-2, uplink transmission can be performed based on the third channel access procedure in addition to the first channel access procedure and the second channel access procedure.

(NR Channel Access Procedure according to Present Embodiment)

In the channel access procedure in the unlicensed channel using NR, non-beamformed channel sensing and beamformed channel sensing can be performed.

The non-beamformed channel sensing is channel sensing based on reception of which directivity is not controlled or channel sensing without direction information. The channel sensing without direction information is, for example, channel sensing obtained by averaging measurement results in all directions. The transmission device (the base station 20 or the terminal device 40) may not recognize the directivity (the angle or the direction) used in the channel sensing.

The beamformed channel sensing is channel sensing based on reception of which directivity is controlled or channel sensing with direction information. That is, the beamformed channel sensing is channel sensing in which the reception beam is directed in a predetermined direction. The transmission device (the base station 20 or the terminal device 40) having a function of performing beamformed channel sensing can perform channel sensing one or more times using different directivities.

The transmission device having a function of performing beamformed channel sensing narrows an area detected by sensing by performing the beamformed channel sensing. As a result, the transmission device (the base station 20 or the terminal device 40) can reduce the frequency of detection of a communication link that does not cause interference and further reduce the terminal problem.

### (Channel Access of Frame Based Equipment (FBE))

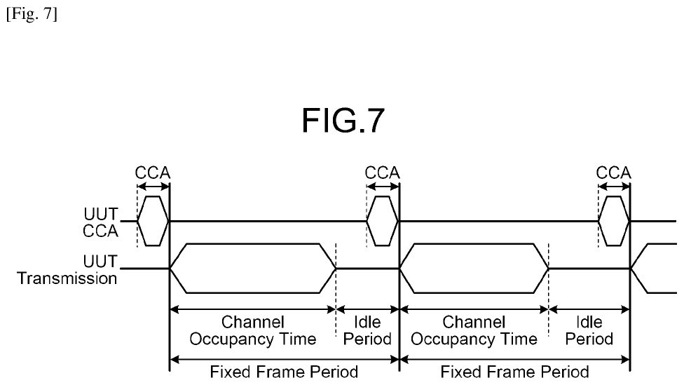

FIG. 7 is a diagram illustrating an outline of a frame based equipment (FBE). The upper part of FIG. 7 illustrates the timing of channel clear assessment (CCA) with the horizontal axis as the time axis. The lower part of FIG. 7 illustrates the transmission timing with the horizontal axis as the time axis.

In a channel access (listen before talk) procedure defined as a frame based equipment (FBE, semi-static channel access, or channel access procedure in semi-static channel occupancy), the channel sensing is performed once before transmission. Based on the sensing result, whether the channel is idle (idle, unoccupied, available, or enable) or busy (busy, occupied, unavailable, or disable) is determined (vacancy determination). In the channel sensing, the power of the channel during predetermined latency is sensed.

The transmission and/or reception configurations used in the frame based equipment has a periodic timing referred to as a fixed frame period.

The fixed frame period is configured in the channel access of the frame based equipment. The fixed frame period is configured between 1 millisecond and 10 milliseconds. The fixed frame period is not allowed to be changed two or more times in 200 milliseconds.

In the channel access of the frame based equipment, the device performs channel sensing immediately before starting transmission from the head of the fixed frame period. The device performs sensing once using one slot configured with 9 microseconds or less. As a result of sensing the channel, when the power value is greater than the predetermined energy detection threshold, the channel is considered to be busy. Alternatively, when the power value is less than the predetermined energy detection threshold, the channel is clear, and the device can perform transmission. The device can perform transmission during a channel occupancy time. The device can perform a plurality of transmissions without performing sensing if the gap between the plurality of transmissions in the channel occupancy time is 16 microseconds or less. Alternatively, when the gap between the plurality of transmissions exceeds 16 microseconds, the device needs to perform additional channel sensing. In the same manner, in the additional channel sensing, the sensing is performed once using one slot.

A channel occupancy time in the channel access of the frame based equipment does not exceed 95% of the fixed frame period. An idle period in the channel access of the frame based equipment is greater than or equal to 5% of the fixed frame period. The idle period is 100 microseconds or more.

The transmission of the response (ACK/NACK or HARQ-ACK) to the transmission from the device may be performed within the channel occupancy time.

### (COT (Channel Occupancy Time))

In the unlicensed band operation, the wireless communication device performs LBT before the signal transmission. As a result of the LBT, if it is determined that the channel is clear, the channel can be occupied during a predetermined time.

The predetermined time during which the channel can be occupied after the LBT is referred to as a channel occupancy time (COT). In the LBE, the COT is defined to fall within the maximum channel occupancy time (maximum COT) defined in Table 1 described above. In the FBE, the COT is defined to fall within 95% of the fixed frame period.

The COT acquired by the wireless communication device may be used for transmission of another wireless communication device that is a communication partner. Transmission of a signal by another wireless communication device (responding device) different from the wireless communication device (initiating device) that acquires the COT by using the COT is referred to as COT sharing. When the COT is shared, other wireless communication devices also need to recognize the COT and the COT length.

The COT length of the COT (base station device start COT or base station device acquisition COT) acquired by the base station 20 is notified to the terminal device 40 using the DCI format 2_0. The terminal device 40 recognizes the length of the base station device start COT based on the COT length indicator included in the DCI format 2_0.

Furthermore, the terminal device 40 may implicitly recognize the COT based on the PDSCH scheduling from the base station 20.

Furthermore, the terminal device 40 may implicitly recognize the COT based on a downlink physical signal (SS/PBCH block, CSI-RS, or DMRS of PDCCH) from the base station 20.

The COT length of the COT (terminal device start COT or terminal device acquisition COT) acquired by the terminal device 40 is notified to the base station 20 using CG-UCI. The base station 20 recognizes the length of the terminal device start COT based on the COT sharing information included in the CG-UCI.

### 1.4. Outline of Embodiment

### 1.4.1 Problem

The sidelink communication so far is assumed to be operated in a licensed band. In addition, a sensing method (sidelink sensing) in the related art for sidelink (SL) resource selection is performed based on decoding of PSCCH and measurement of PSCCH-PSRP or PSSCH-RSRP. As described above, in the sidelink communication in the related art, sensing for other wireless access systems in the unlicensed band is not considered.

However, in the wireless communication system according to the present embodiment, it is assumed that sidelink communication is performed in the unlicensed band. Note that the unlicensed band may mean, for example, a frequency band that is not a frequency band (i.e., licensed band) allowed to be used/operated by only one operator. That is, in the unlicensed band, use and operation may be shared by a plurality of operators. Further or alternatively, in the unlicensed band, use and operation may be shared by a plurality of RATs (not only LTE and NR but also other RATs (for example, WiFi (registered trademark)) may also be included.). From the viewpoint that use and operation may be shared by a plurality of operators and a plurality of RATs, the unlicensed band (the “unlicensed channel” or the like) is also referred to as a shared spectrum. In addition, the communication in the unlicensed band is operation with shared spectrum channel access.

In the unlicensed band, a channel access process (also referred to as LBT or LBT sensing) is performed to acquire the COT as described above. Therefore, when the sidelink communication is performed in the unlicensed band, it is required to simultaneously perform the LBT sensing and the SL sensing with respect to the TxUE40T, but a method of simultaneously performing the LBT sensing and the SL sensing is not defined. Therefore, it has been difficult to realize the sidelink communication using the unlicensed band.

### 1.4.2. Outline of Proposed Technology

Therefore, according to the embodiment in the present disclosure, there is provided a mechanism capable of realizing the sidelink communication using the unlicensed band.

The terminal device 40 (for example, TxUE40T) according to the embodiment of the present disclosure performs sidelink communication with another terminal device 40 (for example, RXUE40R) using the unlicensed band.

The terminal device 40 performs SL sensing related to sidelink communication and LBT sensing related to communication in the unlicensed band. The terminal device 40 selects a transmission resource for sidelink communication with another terminal device 40 by using any one of a first method, a second method, and a third method. The terminal device 40 transmits one or more items of sidelink data by using the selected transmission resource.

The first method is a method of selecting a transmission resource by performing LBT sensing based on a result of SL sensing. The second method is a method of selecting a transmission resource by performing SL sensing based on a result of LBT sensing. The third method is a method of selecting a transmission resource by individually performing SL sensing and LBT sensing.

As a result, the terminal device 40 can perform sidelink communication with another terminal device 40 using the unlicensed band.

### 1.4.3. Definitions

Note that, in the following embodiment, among the terminal devices 40 that perform sidelink communication, the terminal device 40 that transmits at least one of the PSCCH and the PSSCH is also referred to as a terminal device 40T on the transmission side (TxUE40T).

Furthermore, among the terminal devices 40 that perform sidelink communication, the terminal device 40 that receives at least one of the PSCCH and the PSSCH is also referred to as a terminal device 40R on the reception side (RXUE40R). Note that the RXUE40R may transmit the HARQ report relating to the PSSCH to the TxUE40T via the PSFCH.

When the base station 20 and the terminal device 40 are not distinguished from each other, the base station 20 or the terminal device 40 is also simply referred to as a communication device 10. The communication device 10 may include the TxUE40T or the RXUE40R described above.

A device that performs the LBT (CCA, channel access procedure (or simply channel access)) and acquires COT may be referred to as a COT acquisition device or an initiating device.

The device that shares the COT from the COT acquisition device may be referred to as a COT responding device or a responding device. A transmission destination and a transmission method of the COT shared by the COT responding device are determined by a COT response mode described below.

For example, FR1 is defined as a frequency of 450 MHz to 6,000 MHz. Particularly, the unlicensed band in FR1 is a band n46 (5,150 MHz to 5,925 MHz), a band n96 (5,925 MHz to 7,125 MHz), and a band n102.

For example, FR2 is defined as a frequency of 24.25 GHz to 71 GHz. FR2 is a frequency obtained by combining FR2-1 (24.25 GHz to 52.6 GHZ) and FR2-2 (52.6 GHz to 71 GHz). Note that FR2 may be defined as a frequency of 24.25 GHz or more.

### 2. Configuration of Communication System

### 2.1. Configuration Example of Base Station Device

First, the base station 20 is described. The base station 20 is a communication device that operates the cell 30 (see FIG. 1) and provides a wireless communication service to one or more terminal devices 40 positioned inside the coverage of the cell 30. The cell 30 is operated according to an arbitrary wireless communication system such as LTE or NR. The base station 20 is connected to the core network. The core network is connected to a packet data network via a gateway device.

Note that the base station 20 may be configured with a set of a plurality of physical or logical devices. For example, according to the embodiment of the present disclosure, the base station 20 may be distinguished into a plurality of devices of a baseband unit (BBU) and a radio unit (RU) and may be interpreted as an assembly of the plurality of devices. Additionally, or alternatively, according to the embodiments of the present disclosure, the base station 20 may be either or both of the BBU and the RU. The BBU and the RU may be connected by a predetermined interface (for example, eCPRI). Additionally, or alternatively, the RU may be referred to as a remote radio unit (RRU) or a radio DoT (RD). Further or alternatively, the RU may correspond to a gNB-DU described below. Further or alternatively, the BBU may correspond to a gNB-CU described below. Alternatively, the RU may be connected to the gNB-DU described below. Further, the BBU may correspond to a combination of the gNB-CU and the gNB-DU described below. Additionally, or alternatively, the RU may be a device integrally formed with an antenna. The antenna (for example, the antenna integrally formed with the RU) included in the base station 20 may employ an advanced antenna system and support MIMO (for example, FD-MIMO) or beamforming. In the advanced antenna system, the antenna (for example, the antenna integrally formed with the RU) included in the base station 20 may include, for example, 64 transmission antenna ports and 64 reception antenna ports.

Furthermore, the plurality of base stations 20 may be connected to each other. One or the plurality of base stations 20 may be included in a radio access network (RAN). That is, the base station 20 may be simply referred to as a RAN, a RAN node, an access network (AN), or an node. The RAN in LTE is referred to as an enhanced universal terrestrial RAN (EUTRAN). The RAN in NR is referred to as NGRAN. The RAN in W-CDMA (UMTS) is referred to as UTRAN. The base station 20 in LTE is referred to as an evolved node B (eNodeB) or an eNB. That is, the EUTRAN includes one or the plurality of eNodeBs (eNBs). Furthermore, the base station 20 of NR is referred to as a gNodeB or a gNB. That is, the NGRAN includes one or the plurality of gNBs. Further, the EUTRAN may include a gNB (en-gNB) connected to a core network (EPC) in an LTE communication system (EPS). Similarly, the NGRAN may include an ng-eNB connected to a core network 5GC in a 5G communications system (5GS). Further or alternatively, when the base station 20 is an eNB, a gNB, or the like, the base station 20 may be referred to as 3GPP Access. Further or alternatively, when the base station 20 is a wireless access point (for example, an access point of WiFi (Registered Trademark)), the base station 20 may be referred to as non-3GPP access. Further or alternatively, the base station 20 may be an optical extension device referred to as a remote radio head (RRH). Further or alternatively, when the base station 20 is a gNB, the base station 20 may be referred to as a combination or any one of the gNB central unit (CU) and gNB distributed unit (DU) described above. The gNB central unit (CU) hosts a plurality of upper layers (for example, RRC, SDAP, or PDCP) in the access stratum for communication with the UE. Meanwhile, the gNB-DU hosts a plurality of lower layers (for example, RLC, MAC, or PHY) of the access stratum. That is, among messages and information described below, RRC signalling (for example, various SIBs including a MIB and a SIB1, an RRCSetup message, and an RRCReconfiguration message) may be generated by the gNB CU, while DCI and various physical channels (for example, PDCCH and PBCH) described below may be generated by the gNB-DU. Alternatively, in the RRC signalling, for example, a part of configurations (setting information) such as IE: cellGroupConfig may be generated by the gNB-DU, and the remaining configurations may be generated by the gNB-CU. These configurations (setting information) may be transmitted and received by an F1 interface described below. The base station 20 may be configured to be able to com-municate with another base station 20. For example, when the plurality of base stations 20 are eNBs or a combination of an eNB and an en-gNB, the corresponding base stations 20 may be connected to each other by an X2 interface. Further or alternatively, when the plurality of base stations 20 are gNBs or a combination of an gn-eNB and an gNB, the corresponding devices may be connected to each other by an Xn interface. Further or alternatively, when the plurality of base stations 20 are a combination of a gNB central unit (CU) and a gNB distributed unit (DU), the devices may be connected by the F1 interface described above. A message and information (RRC signalling or DCI information, a physical channel) described below may be communicated (for example, via a X2, Xn, or F1 interface) among the plurality of base stations 20.

Further, as described above, the base station 20 may be configured to manage the plurality of cells. A cell provided by the base station 20 is referred to as a serving cell.

The serving cell includes a primary cell (PCell) and a secondary cell (SCell). When the dual connectivity (for example, EUTRA-EUTRA dual connectivity, EUTRA-NR dual connectivity (ENDC), EUTRA-NR dual connectivity with 5GC, NR-EUTRA dual connectivity (NEDC), and NR-NR dual connectivity) is provided to the UE (for example, the terminal device 40), the PCell and zero or one or more SCells provided by the master node (MN) are referred to as a master cell group. Further, the serving cell may include a PSCell (a primary secondary cell or a primary SCG cell). That is, when the dual connectivity is provided to the UE, the PSCell and zero or one or more SCells provided by the secondary node (SN) are referred to as a secondary cell group (SCG). Unless specially configured (for example, PUCCH on SCell), the physical uplink control channel (PUCCH) is transmitted in the PCell and the PSCell but is not transmitted in the SCell. In addition, the radio link failure is also detected in the PCell and the PSCell but is not detected in the SCell (may not be detected). As described above, the PCell and the PSCell have a special role in the serving cell(s) and thus are also referred to as special cells (SpCells). One downlink component carrier and one uplink component carrier may be associated with one cell. In addition, the system bandwidth corresponding to one cell may be divided into a plurality of bandwidth parts. In this case, one or a plurality of bandwidth parts (BWP) may be configured for the UE, and one bandwidth part may be used for the UE as an Active BWP. Furthermore, wireless resources (for example, a frequency band, a numerology (subcarrier spacing), a slot format (slot configuration)) that can be used by the terminal device 40 may be different for each cell, each component carrier, or each BWP.

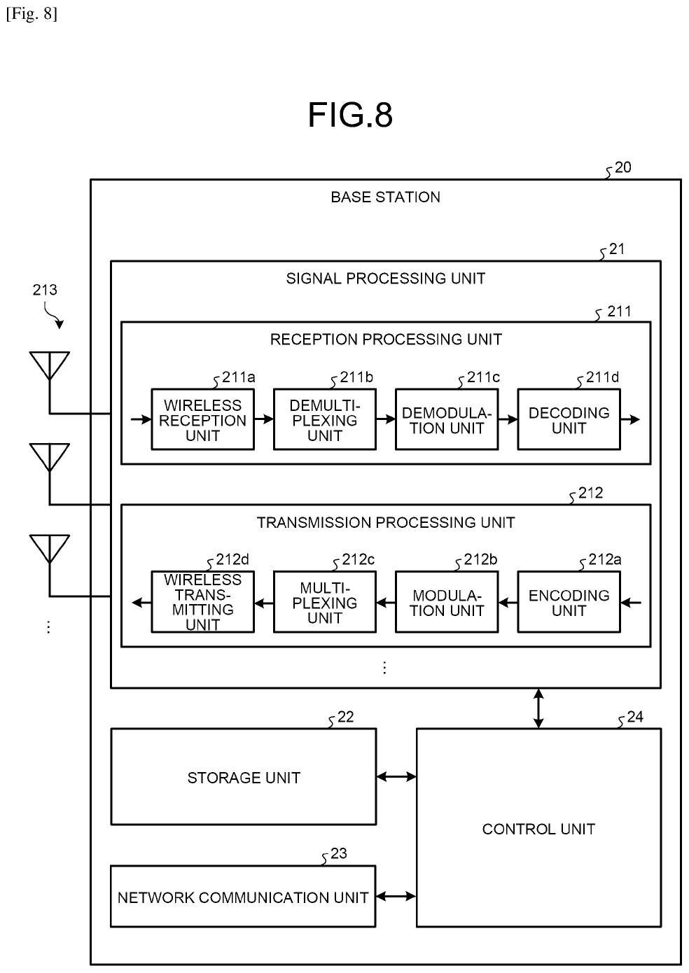

FIG. 8 is a diagram illustrating a configuration example of the base station 20 according to the embodiment of the present disclosure. The base station 20 is a communication device (radio system) that wirelessly communicates with the terminal device 40. The base station 20 is a type of information processing device.

The base station 20 includes a signal processing unit 21, a storage unit 22, a network communication unit 23, and a control unit 24. Note that the configuration illustrated in FIG. 8 is a functional configuration, and the hardware configuration may be different from the functional configuration. Furthermore, the functions of the base station 20 may be distributed in a plurality of physically separated devices to be implemented.

The signal processing unit 21 is a wireless communication interface that wirelessly communicates with other communication devices (for example, the terminal device 40 and the other base station 20). The signal processing unit 21 is a wireless transceiver that operates under the control of the control unit 24. The signal processing unit 21 may support a plurality of wireless access methods. For example, the signal processing unit 21 may support both NR and LTE. The signal processing unit 21 may support other cellular communication methods such as W-CDMA and cdma2000. Furthermore, the signal processing unit 21 may support a wireless LAN communication method in addition to the cellular communication method. Of course, the signal processing unit 21 may correspond to only one wireless access method.

The signal processing unit 21 includes a reception processing unit 211, a transmission processing unit 212, and an antenna 413. The signal processing unit 21 may include the plurality of reception processing units 211, the plurality of transmission processing units 212, and the plurality of antennas 413. Note that, when the signal processing unit 21 supports the plurality of wireless access methods, each unit of the signal processing unit 21 may be individually configured for each wireless access method. For example, when the base station 20 supports NR and LTE, the reception processing unit 211 and the transmission processing unit 212 may be individually configured for NR and LTE.

The reception processing unit 211 processes the uplink signal received via the antenna 413. The reception processing unit 211 includes a wireless reception unit 211a, a demultiplexing unit 211b, a demodulation unit 211c, and a decoding unit 211d.

The wireless reception unit 211a performs down-conversion, removal of an unnecessary frequency component, control of an amplification level, quadrature demodulation, conversion to a digital signal, removal of a guard interval, extraction of a frequency domain signal by fast Fourier transform, and the like on the uplink signal. For example, it is assumed that a wireless access method of the base station 20 is a cellular communication method such as LTE. At this time, the demultiplexing unit 211b demultiplexes an uplink channel such as a physical uplink shared channel (PUSCH) or a physical uplink control channel (PUCCH) and an uplink reference signal from the signal output from the wireless reception unit 211a. The demodulation unit 211c demodulates the received signal using a modulation method such as binary phase shift keying (BPSK) or quadrature phase shift keying (QPSK) with respect to the modulation symbol of the uplink channel. The modulation method used by the demodulation unit 211c may be multi-level QAM such as 16 quadrature amplitude modulation (QAM), 64 QAM, or 256 QAM. The decoding unit 211d performs a decoding process on the demodulated encoded bits of the uplink channel. The decoded uplink data and uplink control information are output to the control unit 24.

The transmission processing unit 212 performs a process of transmitting the downlink control information and the downlink data. The transmission processing unit 212 includes an encoding unit 212a, a modulation unit 212b, a multiplexing unit 212c, and a wireless transmitting unit 212d.

The encoding unit 212a encodes the downlink control information and the downlink data input from the control unit 24 using an encoding method such as block encoding, convolutional encoding, or turbo encoding. The modulation unit 212b modulates the encoded bits output from the encoding unit 212a by a predetermined modulation method such as BPSK, QPSK, 16 QAM, 64 QAM, or 256 QAM. The multiplexing unit 212c multiplexes the modulation symbols of each channel and the downlink reference signal and arranges the multiplexed symbols in a predetermined resource element. The wireless transmitting unit 212d performs various types of signal processing on the signal from the multiplexing unit 212c. For example, the wireless transmitting unit 212d performs processing such as conversion into a time domain by fast Fourier transform, addition of a guard interval, generation of a baseband digital signal, conversion into an analog signal, quadrature modulation, up-conversion, removal of an excessive frequency component, and power amplification. The signal generated by the transmission processing unit 212 is transmitted from the antenna 413.

The storage unit 22 is a storage device capable of reading and writing data, such as a DRAM, an SRAM, a flash memory, or a hard disk. The storage unit 22 functions as storage means of the base station 20.

The network communication unit 23 is a communication interface for communication with another device (for example, another base station 20). For example, the network communication unit 23 is a local area network (LAN) interface such as a network interface card (NIC). The network communication unit 23 may be a universal serial bus (USB) interface configured with a USB host controller, a USB port, and the like. Furthermore, the network communication unit 23 may be a wired interface or a wireless interface. The network communication unit 23 functions as network communication means of the base station 20. The network communication unit 23 communicates with other devices under the control of the control unit 24.

The control unit 24 is a controller that controls each unit of the base station 20. The control unit 24 is realized by, for example, a processor such as a central processing unit (CPU) or a micro processing unit (MPU). For example, the control unit 24 is implemented by causing a processor to execute various programs stored in a storage device inside the base station 20 using a random access memory (RAM) or the like as a work area. Note that the control unit 24 may be realized by an integrated circuit such as an application specific integrated circuit (ASIC) or a field programmable gate array (FPGA). Any of the CPU, the MPU, the ASIC, and the FPGA can be regarded as a controller.

### 2.2. Configuration Example of Terminal Device

Next, the terminal device 40 is described. The terminal device 40 is a communication device that wirelessly communicates with the base station 20 based on control by the base station 20.

The terminal device 40 is a wireless communication device that wirelessly communicates with other devices. The terminal device 40 is, for example, a sensor or a camera device having a communication function, a mobile phone, a smart device (a smartphone or a tablet), a personal digital assistant (PDA), or a personal computer. The terminal device 40 may be a head mounted display, VR goggles, or the like, which has a function of wirelessly transmitting and receiving data. The terminal device 40 may be a moving body such as an automobile or a drone.

For example, the terminal device 40 wirelessly communicates with another terminal device 40 based on control by the base station 20 or autonomously. In this case, the terminal device 40 transmits the sidelink signal to the other terminal device 40 in the PC5 link and receives a sidelink signal from the other terminal device 40. Transmission and reception of sidelink signals by the terminal device 40 are col-lectively referred to as sidelink communication. When performing sidelink communication, the terminal device 40 may be able to use an automatic retransmission technology such as hybrid automatic repeat request (HARQ).

The terminal device 40 may be capable of non-orthogonal multiple access (NOMA) communication with the base station 20. Note that the terminal device 40 may be capable of NOMA communication in communication (sidelink) with other terminal devices 40. Furthermore, the terminal device 40 may be capable of low power wide area (LPWA) communication with other communication devices (for example, the base station 20 and another terminal device 40). In addition, the wireless communication used by the terminal device 40 may be wireless communication using a millimeter wave or a terahertz wave. Note that the wireless communication (including the sidelink communication) used by the terminal device 40 may be wireless communication using radio waves or wireless communication (optical wireless) using infrared rays or visible light.

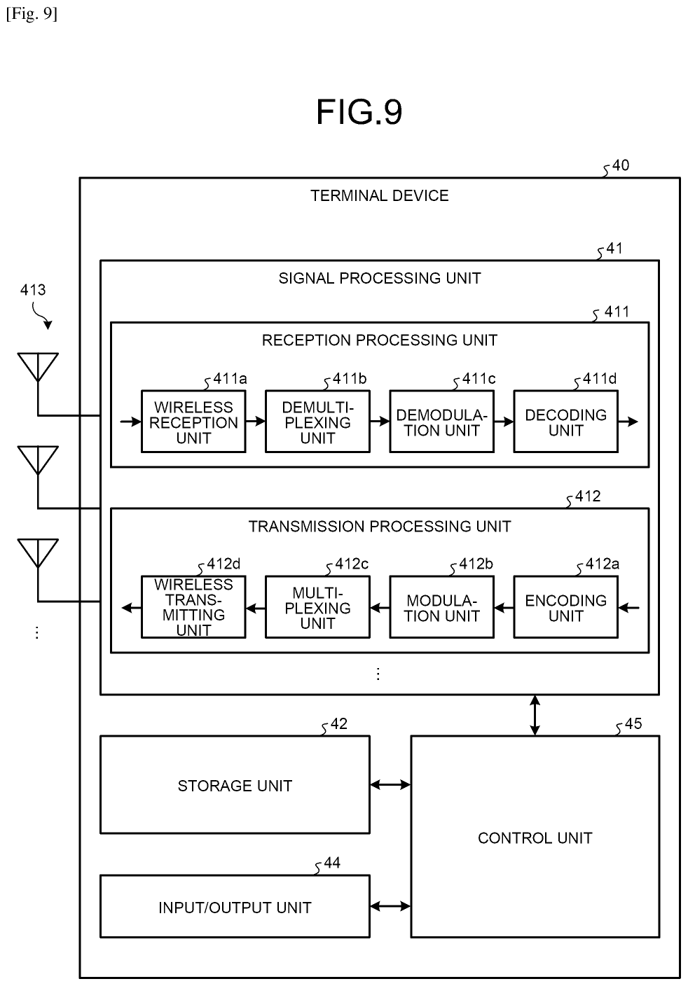

FIG. 9 is a diagram illustrating a configuration example of the terminal device 40 according to the embodiment of the present disclosure. The terminal device 40 is a communication device (radio system) that wirelessly communicates with the base station 20. The terminal device 40 is a type of information processing device.

The terminal device 40 includes a signal processing unit 41, a storage unit 42, an input/output unit 44, and a control unit 45. Note that the configuration illustrated in FIG. 9 is a functional configuration, and the hardware configuration may be different from the functional configuration. Furthermore, the functions of the terminal device 40 may be distributed in a plurality of physically separated configurations to be implemented.

The signal processing unit 41 is a wireless communication interface that wirelessly communicates with other communication devices (for example, the base station 20 and another terminal device 40). The signal processing unit 41 is a wireless transceiver that operates under the control of the control unit 45. The signal processing unit 41 supports one or a plurality of wireless access methods. For example, the signal processing unit 41 supports both NR and LTE. The signal processing unit 41 may support other wireless access methods such as W-CDMA and cdma2000.

The signal processing unit 41 includes a reception processing unit 411, a transmission processing unit 412, and the antenna 413. The signal processing unit 41 may include the plurality of reception processing units 411, the plurality of transmission processing units 412, and the plurality of antennas 413. Note that, when the signal processing unit 41 supports the plurality of wireless access methods, each unit of the signal processing unit 41 may be individually configured for each wireless access method. For example, the reception processing unit 411 and the transmission processing unit 412 may be individually configured by LTE and NR. The configurations of the reception processing unit 411 and the transmission processing unit 412 are similar to those of the reception processing unit 211 and the transmission processing unit 212 of the base station 20.

The storage unit 42 is a storage device capable of reading and writing data, such as a DRAM, an SRAM, a flash memory, or a hard disk. The storage unit 42 functions as storage means of the terminal device 40.

The input/output unit 44 is a user interface for exchanging information with the user. For example, the input/output unit 44 is an operation device for the user to perform various operations, such as a keyboard, a mouse, an operation key, and a touch panel. Alternatively, the input/output unit 44 is a display device such as a liquid crystal display or an organic electroluminescence (EL) display. The input/output unit 44 may be an acoustic device such as a speaker or a buzzer. The input/output unit 44 may be a lighting device such as a light emitting diode (LED) lamp. The input/output unit 44 functions as input/output means (input means, output means, operation means, or notification means) of the terminal device 40.

The control unit 45 is a controller that controls each unit of the terminal device 40. The control unit 45 is realized by, for example, a processor such as a CPU or an MPU. For example, the control unit 45 is implemented by causing a processor to execute various programs stored in a storage device inside the terminal device 40 using a RAM or the like as a work area. Note that the control unit 45 may be realized by an integrated circuit such as an ASIC or an FPGA. Any of the CPU, the MPU, the ASIC, and the FPGA can be regarded as a controller.

### 3. Technical Features

### 3.1. COT Response Mode

According to the embodiment of the present disclosure, a plurality of COT response modes are defined. The COT response mode defines a method of transmission of the COT responding device by using the shared COT, a restriction in the transmission, and the like.

The COT response mode is configured by the base station 20, for example, according to the following conditions. Alternatively, the COT response mode is pre-configured according to the following conditions.

Frequencies used for transmission and reception

Regulations established by areas and countries in which transmission and reception are performed

Operation policies of network operators who operate systems

Note that examples of the frequency used for transmission and reception include FR1 or FR2, a 5/6 GHz band, and a 60 GHz band.

The configuration of the COT response mode may be notified to the plurality of terminal devices 40 as control information common to the cells 30. Alternatively, the configuration of the COT response mode may be individually notified as control information specific to the terminal device 40 or the terminal group.

The configuration of the COT response mode may be semi-statically performed by signaling of the RRC layer or signaling of the MAC layer. Alternatively, the configuration of the COT response mode may be dynamically performed by L1 layer signaling (such as PDCCH, PUCCH, and PSCCH).

### 3.1.1. First COT Response Mode

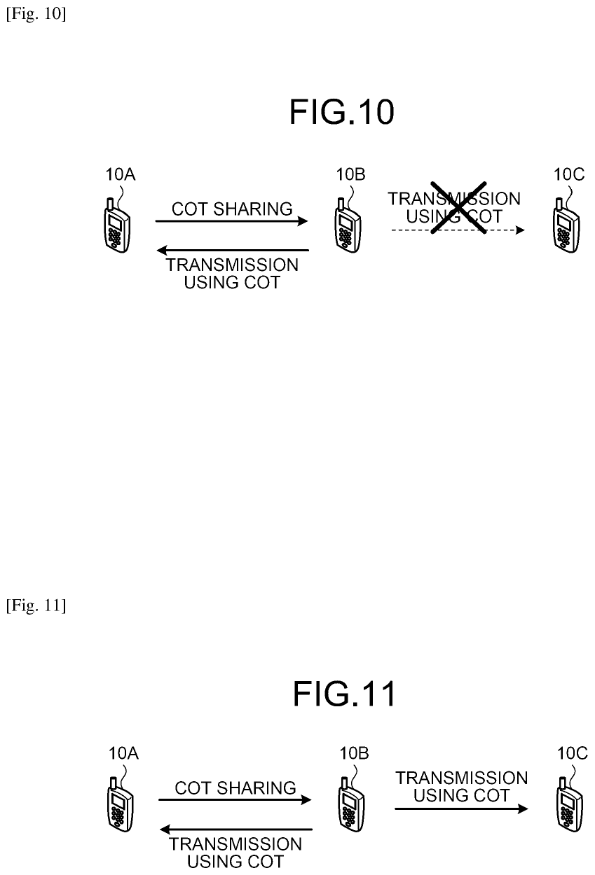

FIG. 10 is a diagram illustrating an example of a first COT response mode according to the embodiment of the present disclosure. In FIG. 10, a communication device 10A is a COT acquisition device. The communication device 10A performs COT sharing with a communication device 10B. That is, the communication device 10B is a COT responding device.

As illustrated in FIG. 10, the communication device 10B may perform transmission to the communication device 10A, which is a COT acquisition device, by using a shared COT. Meanwhile, the communication device 10B cannot perform transmission to a communication device 10C other than the COT acquisition device by using the shared COT.

As described above, the COT responding device sharing the COT can perform transmission using the shared COT to the COT acquisition device sharing the COT. Meanwhile, the COT responding device cannot perform transmission using the shared COT to devices other than the COT acquisition device sharing the COT.

Note that, when the COT acquisition device is one of the base station 20 and the terminal device 40, and the COT responding device is the other of the base station 20 and the terminal device 40, the first COT response mode is the same as the COT sharing method used in the Uu link of the NR-U described above.

Meanwhile, the embodiment of the present disclosure is different from the method used in the Uu link of the NR-U described above in that the COT acquisition device may be the first terminal device 40_1, and the COT responding device may be the second terminal device 40_2.

In the present embodiment, the terminal device 40 performs sidelink communication by sharing the COT. The first COT response mode according to the present embodiment is a mode in which the COT is shared between the COT acquisition device and the COT responding device, and the COT responding device performs Uu link communication or sidelink communication with the COT acquisition device. The sidelink communication performed here is communication using a sidelink resource in the COT.

### 3.1.2. Second COT Response Mode

FIG. 11 is a diagram illustrating an example of a second COT response mode according to the embodiment of the present disclosure. In FIG. 11, the communication device 10A is a COT acquisition device. The communication device 10A shares COT with the communication device 10B. That is, the communication device 10B is a COT responding device.

As illustrated in FIG. 11, the communication device 10B may perform transmission to the communication device 10A, which is a COT acquisition device, by using a shared COT. Furthermore, the communication device 10B may perform transmission to the communication device 10C other than the COT acquisition device by using the shared COT. That is, the communication device 10B sharing the COT can perform transmission using the COT to an arbitrary communication device 10 including the communication device 10A that acquires the COT.

As described above, the COT responding device sharing the COT can perform transmission using the shared COT to an arbitrary communication device 10 including the COT acquisition device sharing the COT.

The second COT response mode is different from the first COT response mode in that the COT responding device can transmit a signal to the communication device 10 other than the COT acquisition device sharing the COT.

According to the present embodiment of the present disclosure, the second COT response mode is a mode in which the COT is shared between the COT acquisition device and the COT responding device, and the COT responding device performs Uu link communication or sidelink communication with the COT acquisition device and other devices. The sidelink communication performed here is communication using a sidelink resource in the COT.

Note that, as the second COT response mode, a transmission method (transmission restriction) may be defined (regulated or configured) according to whether the transmission destination of the communication device 10B is the communication device 10A or the communication device 10C. That is, a transmission method (transmission restriction) may be defined according to whether the transmission destination of the COT responding device is the COT acquisition device.

As an example, the transmission restriction may be a configured LBT category (Channel access type: CAT).

For example, when the transmission destination of the communication device 10B is the communication device 10A, the LBT category used in the second COT response mode is the same as the LBT category used in the first COT response mode.

For example, when the transmission destination of the communication device 10B is other than the communication device 10A (for example, the communication device 10C), the LBT category used in the second COT response mode is a LBT category stricter (for example, the length of the CCA (duration in which the CCA is performed) and the number of times of the CCA (the number of times of the CCA in a predetermined period) is large) than the first COT response mode in terms of the length of the CCA, the number of times of the CCA, and the like.

Specifically, when the transmission destination of the communication device 10B is the communication device 10A, the Type 2C channel access may be used in the second COT response mode. However, when the transmission destination of the communication device 10B is other than the communication device 10A (for example, the communication device 10C), the Type 2C channel access is not used in the second COT response mode. In this case, for example, the Type 2A or Type 2B channel access is used in the second COT response mode, and no other CAT is used.

As another example, the transmission restriction may be a transmittable time length.

For example, when the transmission destination of the communication device 10B is the communication device 10A, the transmittable time length of the second COT response mode is the same as the transmittable time length (the maximum COT or the maximum channel occupancy time) of the first COT response mode.

For example, when the transmission destination of the communication device 10B is other than the communication device 10A (for example, the communication device 10C), the transmittable time length of the second COT response mode is shorter than the transmittable time length of the first COT response mode.

As another example, the transmission restriction may be a transmission power.

For example, when the transmission destination of the communication device 10B is the communication device 10A, the transmission power in the second COT response mode is the same as the transmission power in the first COT response mode.

For example, when the transmission destination of the communication device 10B is other than the communication device 10A (for example, the communication device 10C), the transmission power transmittable in the second COT response mode is lower than the transmission power transmittable in the first COT response mode.

### 3.2. COT Sharing Mode

According to the embodiment of the present disclosure, the plurality of COT sharing modes are defined. According to the COT sharing mode, a method of sharing the acquired COT, a restriction in sharing, and the like are defined.

The COT sharing mode is configured by the base station 20, for example, according to the following conditions. Alternatively, the COT sharing mode is pre-configured according to the following conditions.

Frequencies used for transmission and reception

Regulations established by areas and countries in which transmission and reception are performed

Operation policies of network operators who operate systems

Note that examples of the frequency used for transmission and reception include FR1 or FR2, a 5/6 GHz band, and a 60 GHz band.

Note that the COT sharing mode may be configured individually or in combination with the COT response mode described above. In addition, when the COT sharing mode and the COT response mode are configured, respectively, modes that can be configured may be limited. For example, when the COT sharing mode 2 is configured, the COT response mode 2 is configured (that is, the mode is not configured as the COT response mode 1). In other words, when the COT response mode 1 is configured, the COT sharing mode 2 cannot be configured. In other words, one of the plurality of COT sharing modes may be associated with a predetermined one of the plurality of COT response modes.

The configuration of the COT sharing mode may be notified to the plurality of terminal devices 40 as control information common to the cells 30. Alternatively, the configuration of the COT sharing mode may be individually notified as the control information specific to the terminal device 40 or the terminal group.

The configuration of the COT sharing mode may be semi-statically performed by signaling of the RRC layer or signaling of the MAC layer. Alternatively, the configuration of the COT response mode may be dynamically performed by L1 layer signaling (such as PDCCH, PUCCH, and PSCCH).

### 3.2.1. First COT Sharing Mode

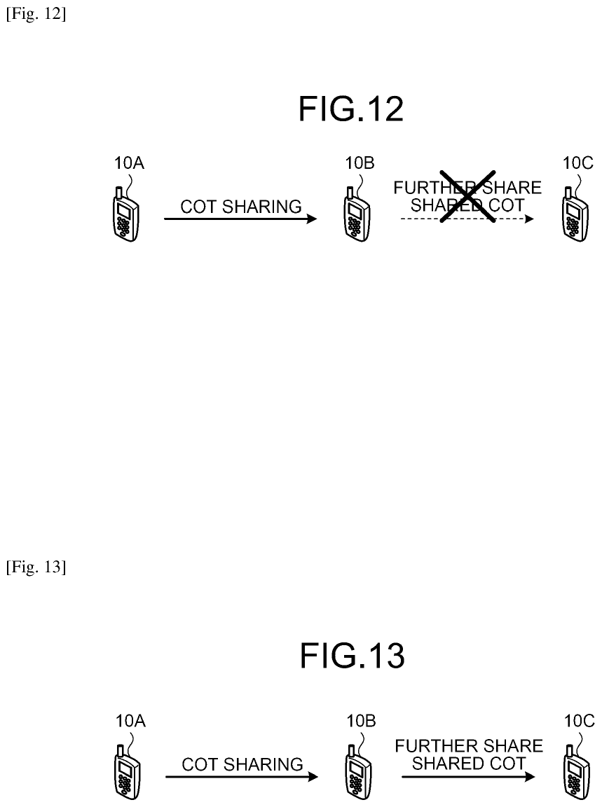

FIG. 12 is a diagram illustrating an example of a first COT sharing mode according to the embodiment of the present disclosure. In FIG. 12, the communication device 10A is a COT acquisition device. The communication device 10A shares COT with the communication device 10B. That is, the communication device 10B is a COT responding device.

As illustrated in FIG. 12, the communication device 10A may share the COT with the communication device 10B that is a COT responding device. Meanwhile, the communication device 10B cannot further share a part or all of the shared COT with the communication device 10C other than the COT acquisition device. That is, the communication device 10 that can share the COT is limited to the communication device 10A that is the COT acquisition device.

As described above, the COT acquisition device that acquires the COT can share the COT with the COT responding device. Meanwhile, the COT responding device cannot share at least a part of the COT with a device other than the COT acquisition device. As described above, in the first COT sharing mode, COT sharing with devices other than the COT responding device and the COT acquisition device is limited.

Note that, when the COT acquisition device is one of the base station 20 and the terminal device 40, and the COT responding device is the other of the base station 20 and the terminal device 40, the first COT sharing mode is the same as the COT sharing performed in the Uu link of the NR-U described above.

However, the embodiment of the present disclosure is different from COT sharing performed in the Uu link of the NR-U described above in that the COT acquisition device may be the first terminal device 40_1, and the COT responding device may be the second terminal device 40_2.

As described above, the first COT sharing mode according to the present embodiment is not limited to the Uu link communication and is a mode in which the COT is shared between the COT acquisition device and the COT responding device also in the sidelink communication.

<3.2.2. Second COT Sharing Mode>

FIG. 13 is a diagram illustrating an example of a second COT sharing mode according to the embodiment of the present disclosure. In FIG. 13, the communication device 10A is a COT acquisition device. The communication device 10A shares COT with the communication device 10B. That is, the communication device 10B is a COT responding device.

As described above, also in the second COT sharing mode, similarly to the first COT sharing mode, the communication device 10A as the COT acquisition device can share the COT with the communication device 10B as the COT responding device. Furthermore, in the second COT sharing mode, the communication device 10B may further share the COT shared from the communication device 10A with another communication device 10C. In other words, the COT acquired by the COT acquisition device can be relayed among the plurality of communication devices 10.

The second COT sharing mode is different from the first COT sharing mode in that the COT responding device can share the COT shared by the COT acquisition device with another communication device 10. In the second COT sharing mode, any one of the COT acquisition device and the COT responding device may perform COT sharing.

According to the present embodiment of the present disclosure, the second COT response mode is a mode in which the COT is shared between the COT acquisition device and the COT responding device, and the corresponding COT is shared between the COT responding device and another device (for example, the communication device 10C).

Note that, in the second COT sharing mode, the number of relays (the number of hops) of the COT may be limited to a predetermined number of times. The number of relays of the COT is, for example, the number of times another device shares the COT as the COT responding device. For example, the number of relays of the COT may be one at maximum.

For example, in FIG. 13, the COT acquired by the communication device 10A can be shared by the communication device 10B. As a result, the communication device 10B becomes the COT responding device (hereinafter, also referred to as a first COT responding device).

The communication device 10B may share the COT with the communication device 10B different from the communication device 10A that is the COT acquisition device. As a result, the communication device 10C becomes the COT responding device (hereinafter, also referred to as a second COT responding device).

However, when the number of relays of the COT is one at maximum, the communication device 10C as the second COT responding device cannot share the COT with other devices. In this manner, the number of times of sharing (the number of relays) of the COT may be limited.

Note that, in a case of sharing the COT, the device (for example, the communication devices 10A and 10B) that notify the COT sharing may notify the device (for example, the communication devices 10B and 10C) that receives the notification of the COT sharing of the number of relays of the COT. For example, the device that notifies the COT sharing notifies information indicating the number of relays (the number of hops) of the COT to be shared when notifying the COT sharing. As a result, the device that receives the notification of the COT sharing can recognize whether the COT can be further shared.

Note that the number of relays of the COT is not limited to one and may be two or more.

Furthermore, as the second COT sharing mode, a transmission method (transmission restriction) may be defined (regulated or configured) according to the number of relays of the COT. That is, the transmission method (limitation) can be defined according to whether the device is the COT acquisition device (the number of relays: 0), the first COT responding device (the number of relays: 0), or the second COT responding device (the number of relays: 1).

As an example, the transmission restriction may be a configured LBT category (Channel access type: CAT).

For example, an LBT category used in a device in which the number of relays is zero, that is, the COT acquisition device, is the same as the LBT category used in the COT acquisition device in the first COT response mode. Similarly, the LBT category used in the device in which the number of relays is zero, that is, the first COT responding device, is the same as the LBT category used in the COT responding device in the first COT response mode.

For example, the LBT category used in the device in which the number of relays is one, that is, the second COT responding device, is a LBT category stricter than the device in which the number of relays is zero, that is, the COT acquisition device and the first responding device in terms of the CCA length, the number of times of the CCA, and the like.

Specifically, the Type 2C channel access may be used in the first COT responding device. Meanwhile, the Type 2C channel access is not used in the second COT responding device. In this case, for example, the Type 2A or Type 2B channel access is used in the second COT responding device, and no other CAT is used.

As described above, in the second COT sharing mode, the LBT category may be defined as the transmission method (restriction) according to the number of relays of the COT. For example, as the number of relays of the COT increases, a strict LBT category, for example, in terms of the length of the CCA and the number of times of the CCA may be applied.

As another example, the transmission restriction may be a transmittable time length.

For example, the transmittable time length of the device in which the number of relays is zero, that is, the COT acquisition device is the same as the transmittable time length of the COT acquisition device in the first COT response mode. Similarly, the transmittable time length of the device in which the number of relays is zero, that is, the first COT responding device, is the same as the transmittable time length of the COT responding device in the first COT response mode.

For example, the transmittable time length of the device in which the number of relays is one, that is, the second COT responding device is shorter than the transmittable time length of the device in which the number of relays is zero, that is, the COT acquisition device and the first responding device.

As described above, in the second COT sharing mode, the transmittable time length as the transmission method (restriction) may be defined according to the number of relays of the COT. For example, as the number of relays of the COT increases, a shorter time length may be applied as the transmittable time length.

As another example, the transmission restriction may be a transmission power.

For example, transmittable transmission power of the device in which the number of relays is zero, that is, the COT acquisition device, is the same as transmittable transmission power of the COT acquisition device in the first COT response mode. Similarly, the transmittable transmission power of the device in which the number of relays is zero, that is, the first COT responding device, is the same as the transmittable transmission power of the COT responding device in the first COT response mode.

For example, the transmittable transmission power of the device in which the number of relays is one, that is, the second COT responding device is lower than the transmittable transmission power of the device in which the number of relays is zero, that is, the COT acquisition device and the first responding device.

As described above, in the second COT sharing mode, the transmission power as the transmission method (restriction) may be defined according to the number of relays of the COT. For example, as the number of relays of the COT increases, lower transmission power may be applied.

<3.3. Sensing Method for SL Communication in Unlicensed Band>

As a sensing method (hereinafter, also referred to as an SL-U sensing method) for sidelink communication in the unlicensed band, the following one or more methods may be defined.

Note that, in the present embodiment, the SL sensing for SL resource selection includes the same method as the SL sensing in the related art described above or a method changed based on the SL sensing in the related art. Further, in the present embodiment, the channel access procedure (LBT) for acquiring the COT includes the same method as the channel access procedure in the related art described above or a method changed based on the channel access procedure in the related art.

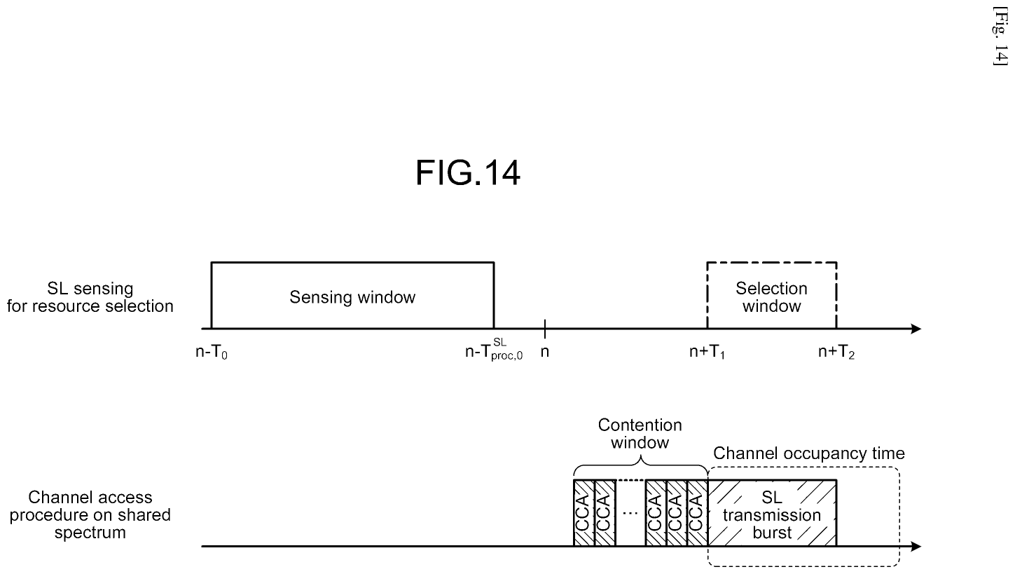

FIG. 14 is a diagram illustrating an outline of a sensing method according to the embodiment of the present disclosure. In FIG. 14, the SL sensing for SL resource selection (see the upper diagram) and the channel access procedure (LBT) (in the shared channel) for COT acquisition (see the lower diagram) are illustrated. The SL sensing for SL resource selection (hereinafter, also referred to as SL sensing) and the channel access procedure for COT acquisition (hereinafter, also referred to as LBT sensing) are performed by the TxUE40T.

According to the present embodiment, after the time n, the TxUE40T performs both the selection of the SL resource for the selection window based on the SL sensing result and the channel access for COT acquisition and determines the resource for SL transmission. Here, the time n is a time point at which the SL resource selection is triggered (a time point when the traffic of the SL communication occurs).

Note that FIG. 14 illustrates a case where the sensing method is full sensing as an example, but other sensing results (methods) such as the partial sensing described above, periodic based partial sensing, or contiguous partial sensing may be used.

Note that, in the present embodiment, examples of the resources in the time domain include the following resources.
Slot (time resource configured with 14 OFDM symbols)
Subframes (time resource configured with 1 millisecond)
OFDM symbol
Resource including predetermined number of OFDM symbols (for example, subslot configured with the number of symbols less than 14)

Examples of the resources in the frequency domain include the following resources.
Resource Block
Subchannel (frequency resource of SL transmission configured with predetermined number of resource blocks)
Bandwidth part (BWP)
Component carrier

Note that, in the present embodiment, the resource in the frequency domain may be a resource of a predetermined frequency bandwidth, and for example, 20 MHz may be used.

Hereinafter, first to third sensing methods are described as examples of SL sensing of the present embodiment. Details of each method are described below, and an outline is described as follows.

In the first and second sensing methods, one operation of SL resource selection by SL sensing and a channel access procedure (LBT sensing) for COT acquisition is performed based on parameters and sensing results of the other.

In the first sensing method and the second sensing method, whether the operation after the SL resource selection is triggered is SL sensing or LBT sensing is different. That is, in the first sensing method and the second sensing method, the order of the SL sensing and the LBT sensing is different.

In the third sensing method, unlike the first and second sensing methods, the SL sensing and the LBT sensing are individually performed. In the third sensing method, the SL resource used for the SL transmission is selected based on each result of the sensing individually performed.

### (First Sensing Method)

After SL resource selection is triggered, the TxUE40T first selects SL resources for SL transmission (SL transmission burst) based on the SL sensing.

Next, the TxUE40T acquires the COT by the LBT sensing (channel access procedure) for the selected SL resource. The TxUE40T transmits the SL data using the acquired COT.

### (Second Sensing Method)

After the SL resource selection is triggered, the TxUE40T first acquires the COT by the LBT sensing (channel access procedure).

Next, the TxUE40T performs the SL resource selection based on the SL sensing with respect to the resource in the acquired COT. Finally, the TxUE40T transmits the SL data using the selected SL resource.

### (Third Sensing Method)

After the SL resource selection is triggered, the TxUE40T individually (independently) performs the SL sensing and the LBT sensing (channel access procedure).

The TxUE40T determines the SL resource to be used for the SL transmission based on the SL resource selected based on the SL sensing and the COT acquired by the LBT sensing (channel access procedure). The TxUE40T transmits the SL data using the determined SL resource.

Note that, in the first to third sensing methods described below, execution of all steps is not essential, and at least a part of steps may be executed. Alternatively, each of the first to third sensing methods may be realized by a combination of a plurality of at least a part of steps.

### 3.3.1. Details of First Sensing Method

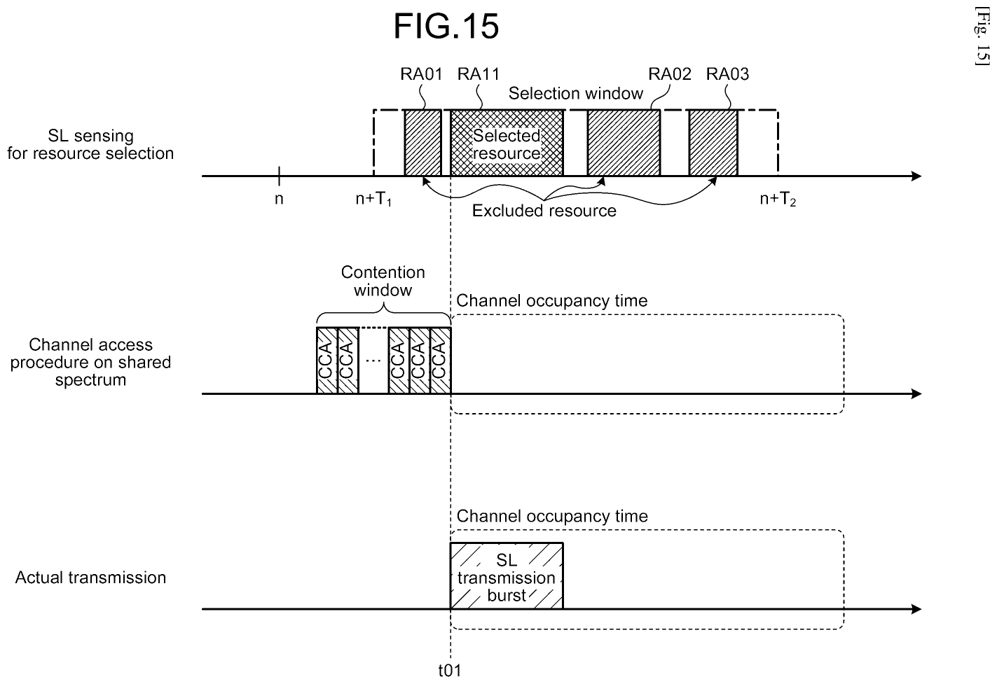

FIG. 15 is a diagram illustrating an example of a first sensing method according to the embodiment of the present disclosure. In FIG. 15, the SL sensing for SL resource selection (see the upper diagram), the channel access procedure (LBT) (in the shared channel) for COT acquisition (see the middle diagram), and actual transmission (see the lower diagram) are illustrated.

The TxUE40T executes the following procedure (step) as the first sensing method.

(C1) At the time n (see the upper diagram of FIG. 15), a trigger for SL resource selection occurs. That is, the SL transmission traffic (SL-SCH) is generated (slot n).

(C2) The TxUE40T determines the selection windows (SL resource selection windows) [n+T₁ and n+T₂]. For example, the TxUE40T may determine the Selection windows (time intervals) [n+T₁ and n+T₂] in the same manner as step (A1) in the SL sensing method in the related art described above. For example, in FIG. 15, the TxUE40T determines time intervals from n+T₁ to n+T₂ after the time n as the selection windows.

(C3) The TxUE40T performs the SL sensing in the determined selection window. The TxUE40T determines the set S_{A} in the selection window based on the SL sensing result. For example, the TxUE40T removes the any candidate single-slot resource R_{x,y} from the set S_{A} in a manner similar to steps (A2) to (A7) in the SL sensing method in the related art described above.

(C4) The TxUE40T selects a resource (selected resource) based on the set S_{A} from which the any candidate single-slot resource R_{x,y} is removed. For example, the TxUE40T selects a resource in a manner similar to step (A8) in the SL sensing method in the related art described above. For example, in FIG. 15, the TxUE40T removes resources RA01 to RA03 from the set S_{A} as any candidate single-slot resource R_{x,y}, and determines a resource RA11 as the selected resource.

(C5) The TxUE40T performs LBT sensing (channel access procedure) based on the selected resource and acquires the COT. In the example of FIG. 15, the TxUE40T performs the LBT sensing and acquires the COT including the selected resources.

(C6) The TxUE40T transmits the SL transmission burst (such as one or more PSCCH/PSSCH) in the acquired COT.

Details of each procedure is described below.

### Step (C2)

First, details of step (C2) are described.

The configuration of the selection window (determination of T₁ and/or T₂) may be performed, for example, based on the following parameters relating to the channel access procedure.
Time length of SL transmission burst (number of slots)
Channel occupancy time (COT)
Contention window (CW or contention window)
Channel access type

### (Time Length of SL Transmission Burst)

The configuration of the selection windows (determination of T₁ and/or T₂) may be performed, for example, based on the time length (the number of slots) of SL transmission burst (a resource required for the corresponding SL transmission).

For example, the time length (that is, T₂−T₁) of the selection window may be configured to be the same as the time length of the SL transmission burst.

For example, the time length (that is, T₂−T₁) of the selection window may be configured to be longer than the time length of the SL transmission burst. In this case, for example, the TxUE40T extends the end time point (that is, T₂) of the selection window (increases the value thereof) without changing the start time point (that is, T₁) of the selection window.

Here, for example, as a result of the LBT sensing, there is a case where the start time point of the COT is not the same as the start time point of the selection window (or there is a possibility that the time points may not be the same). That is, there is a possibility that the start time point of the period when the SL transmission can actually be performed is shifted to a point after the start time point of the selection window.

As described above, even if the start time point of the period when the SL transmission can be actually performed is shifted to a point after the start time point of the selection window, the end time point of the period when the SL transmission can be actually performed (the end time point of the selection window) is not shifted.

Therefore, when the time length of the selection window is the same as the time length of the SL transmission burst, there is a concern that the TxUE40T cannot secure the time length of the SL transmission burst. However, even in such a case, by configuring the time length of the selection window to be longer than the time length of the SL transmission burst, there is a high possibility that the TxUE40T can secure the time length of the SL transmission burst.

For example, T₂ may be the same as the remaining packet delay budget or may be determined based on the remaining packet delay budget.

### (Channel Occupancy Time)

For example, the time length of the selection window (that is, T₂−T₁) or the end time point of the selection window (that is, T₂) may be configured to be equal to or longer than the length of the COT that may be acquired by the channel access procedure.

As described above, the length of the COT varies depending on the channel access type and/or the channel access priority class. Therefore, the time length (that is, T₂−T₁) of the selection window or the end time point (that is, T₂) of the selection window may be configured according to the type, priority, or the like of the corresponding SL transmission.

Specifically, in the Type 1 channel access, when the channel access priority class is 1, 2, 3, or 4, the selection window can be configured to be equal to or larger than 2 ms, 3 ms, 8 ms or 10 ms, respectively.

### (Contention Window)

For example, the start time point (that is, T₁) of the selection window is determined according to the CW size (the time length of the CW). For example, T₁ is configured to be after a predetermined CW. That is, T₁ can be configured to be a value equal to or larger than the time length of the predetermined CW. Note that the determination of T₁ 1 may further include and consider the processing time (T_{proc,1}^{SL}) of the UE (the terminal device 40).

The predetermined CW includes any of the following.
CW (that is, randomly selected CW) used in the corresponding channel access procedure
Predetermined value (maximum value, minimum value, average value, or median value) of CW that may be taken by channel access priority class for the corresponding SL transmission

### (Channel Access Type)

For example, T₁ and/or T₂ is determined based on a predetermined value defined or configured according to the channel access type.

### Step (C3)

Details of step (C3) are described.

In the unlicensed band, transmission burst needs to be transmitted by using consecutive resources. Therefore, in the determined set S_{A}, there is a case where resources of consecutive time lengths corresponding to the SL transmission burst of the corresponding SL transmission cannot be selected (is not selected) (or there is a case where a selectable number (the number of candidates) is small). In this case, the TxUE40T changes the parameter related to the sidelink sensing, performs the SL sensing again, and selects the selected resource (SL sensing resource). For example, the TxUE40T may change the set S_{A} by changing the threshold value of the RSRP measurement.

For example, the TxUE40T performs any one of the following operation examples in addition to or in place of step (A7) in the SL sensing method in the related art described above. That is, in the resources remaining in the set S_{A}, consecutive resources (the number of slots or the number of candidates thereof) may be smaller than a predetermined value obtained based on the parameter configured by the RRC signaling or resources required for predetermined SL transmission. In this case, the TxUE40T performs any one of the following operations.

Operation Example 1: The TxUE40T increases the value of the RSRP threshold by a predetermined value (for example, 3 dB) and performs the SL sensing method in the related art from step (A4) again.

Operation Example 2: The TxUE40T changes the frequency channel and performs the first sensing method from step (C2) again. The same selection windows (that is, T₁ and T₂) may be used.

Operation Example 3: The TxUE40T returns to step (C2) and reconfigures the selection window.

Note that, in the SL sensing method in the related art described above, a subchannel including a predetermined number of resource blocks is used as a unit of frequency resources. Meanwhile, in the SL sensing (SL-U sensing method) performed by the first sensing method, the subchannel size may be defined according to the frequency band (FR).

For example, in FR1, the subchannel size used in the SL sensing (SL-U sensing method) performed by the first sensing method is 20 MHz.

In the SL sensing (SL-U sensing method) performed in the first sensing method, the TxUE40T may measure the RSSI in addition to (or by changing) the SL sensing method in the related art described above. The TxUE40T excludes the S any candidate single-slot resource R_{x,y} from the set S_{A}, for example, according to whether the measured RSSI is higher than the threshold.

More specifically, the TxUE40T performs PSCCH decoding and RSRP measurement similarly to the SL sensing method in the related art, for example, in units of a 20-MHz width and a 1-ms slot. In addition, in order to reduce collision with another wireless access system, the TxUE40T measures the RSSI of all or a part of the resources (the resources on which the PSCCH decoding and the RSRP measurement are performed).

### Step (C5)

Details of step (C5) are described.

The TxUE40T performs the channel access procedure so that the start time point of the COT or the end time point of the CW become the start time point of the selected resource (see time t01 in FIG. 15).

However, depending on a result of the LBT, the start time point of the COT or the end time point of the CW may be the same as, before, or after the start time point of the selected resource.

Note that, in the selected resources (sensing windows), resources not included in the COT (not overlapping) may be excluded resources. That is, the corresponding resource can be excluded from the set SA.

In addition, the start time point of the selected resource and the implementation timing of the channel access procedure may be defined by an expression of performing the channel access procedure so that the start time point of the selected resource starts no earlier than the start time point of the COT or the end time point of the CW.

As a result of the LBT sensing, when the COT cannot be acquired at the start time point of the selected resource (that is, when the start time point of the COT or the end time point of the CW is later than the start time point of the selected resource), the TxUE40T performs any one of the following operations.

In other words, when the end time point of the CW or the start time point of the COT is the same as the start time point of the selected resource or earlier than the start time point of the selected resource, the TxUE40T selects the selected resource as the transmission resource. Otherwise, the TxUE40T performs one of the following operations.

Note that this operation is similarly performed not only in the first sensing method but also in a case where such a status occurs according to the present embodiment.

Operation Example 1: The TxUE40T performs resource reselection. In the resource reselection, the TxUE40T may reuse the set S_{A} that has already been determined or may newly perform the first sensing method from step (C2) and determine the set SA again.

Operation Example 2: The TxUE40T cancels the SL transmission.

Operation Example 3: The TxUE40T performs the SL transmission by using the resource from the COT acquisition time point to the end time point of the selected resource. That is, the SL transmission is performed using resources less than the selected resources.

Operation Example 4: The TxUE40T performs the SL transmission by using the resource having the time length of the selected resource from the COT acquisition time point. That is, the SL transmission is performed by using the resources after the selected resources. In this case, the TxUE40T may perform the SL transmission according to whether the resources after the selected resource are available based on the set SA. Alternatively, the TxUE40T may perform the SL transmission using the resources after the selected resource regardless of the corresponding set SA. Note that, when the resources after the selected resource are used, the SL transmission may be limited so that the resource length after the selected resource does not exceed a predetermined time length.

### Step (C6)

Details of step (C6) are described.

If the start time point of the COT or the end time point of the CW is not a slot boundary, a dummy signal may be transmitted up to a predetermined slot boundary in which the selected resource can be configured.

If the start time point of the COT or the end time point of the CW is earlier than the start time point of the selected resource (that is, when there is a time between the start time point of the COT or the end time point of the CW and the start time point of the selected resource), a dummy signal may be transmitted during that time.

### 3.3.2. Details of Second Sensing Method

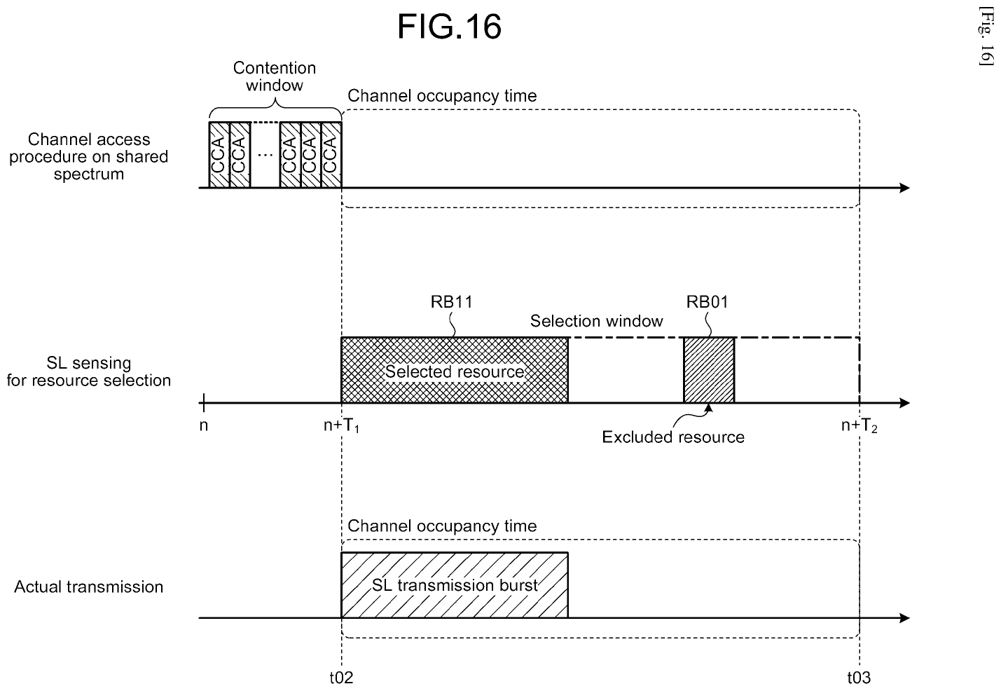

FIG. 16 is a diagram illustrating an example of a second sensing method according to the embodiment of the present disclosure. In FIG. 16, the channel access procedure (LBT) (in the shared channel) for COT acquisition (see the upper diagram), the SL sensing for SL resource selection (see the middle diagram), and actual transmission (see the lower diagram) are illustrated.

The TxUE40T executes the following procedure (step) as the second sensing method.

(D1) At the time n (see the middle diagram of FIG. 16), a trigger for the SL resource selection occurs. That is, the SL transmission traffic (SL-SCH) is generated.

(D2) The TxUE40T performs the channel access procedure based on the priority of the SL-SCH and acquires the COT. For example, in FIG. 16, the TxUE40T acquires the COT in a period from a time t02 to a time t03.

(D3) The TxUE40T determines the acquired COT as the selection windows (SL resource selection windows) [n+T₁ and n+T₂]. For example, in FIG. 16, the TxUE40T sets the time t02 as the start time point of the selection window and sets the time t03 as the end time point of the selection window.

(D4) The TxUE40T performs the SL sensing in the determined selection window. The TxUE40T determines the set S_{A} in the selection window based on the SL sensing result. For example, the TxUE40T removes the any candidate single-slot resource R_{x,y} from the set S_{A} in a manner similar to steps (A2) to (A7) in the SL sensing method in the related art described above.

(D5) It is assumed that there is no excluded resource (resource excluded in step (D4)) in the selection window, or there is no excluded resource until a time corresponding to SL transmission burst from the head in the selection window. In this case, the TxUE40T selects the SL resource (selected resource) based on the set S_{A} determined in step (D4).

If the selected resource can be selected from the start time point of the selection window, the TxUE40T selects the selected resource from the start time point of the selection window, for example, as the SL transmission burst.

In the example of FIG. 16, there is an excluded resource (a resource RB01) in the selection window, but the corresponding excluded resource (the resource RB01) is after the time corresponding to the SL transmission burst from the head in the selection window. Therefore, the TxUE40T selects the resource RB11 as the selected resource based on the set S_{A} determined in step (D4).

The operation of the TxUE40T when there is an excluded resource in the selection window is described below.

(D6) The TxUE40T transmits the SL transmission burst (such as one or more PSCCH/PSSCH) by using the selected resource.

Details of each procedure is described below.

### Step (D3)

First, details of step (D3) are described.

The start time point (that is, T₁) of the selection window is the same as the start time point of the COT or the end time point of the CW (see the time t02 in FIG. 16) or later than the start time point of the COT or the end time point of the CW. Furthermore, a predetermined time length (for example, a processing time of the UE (the terminal device 40)) may be included between the start time point of the selection window (that is, T₁) and the start time point of the COT or the end time point of the CW.

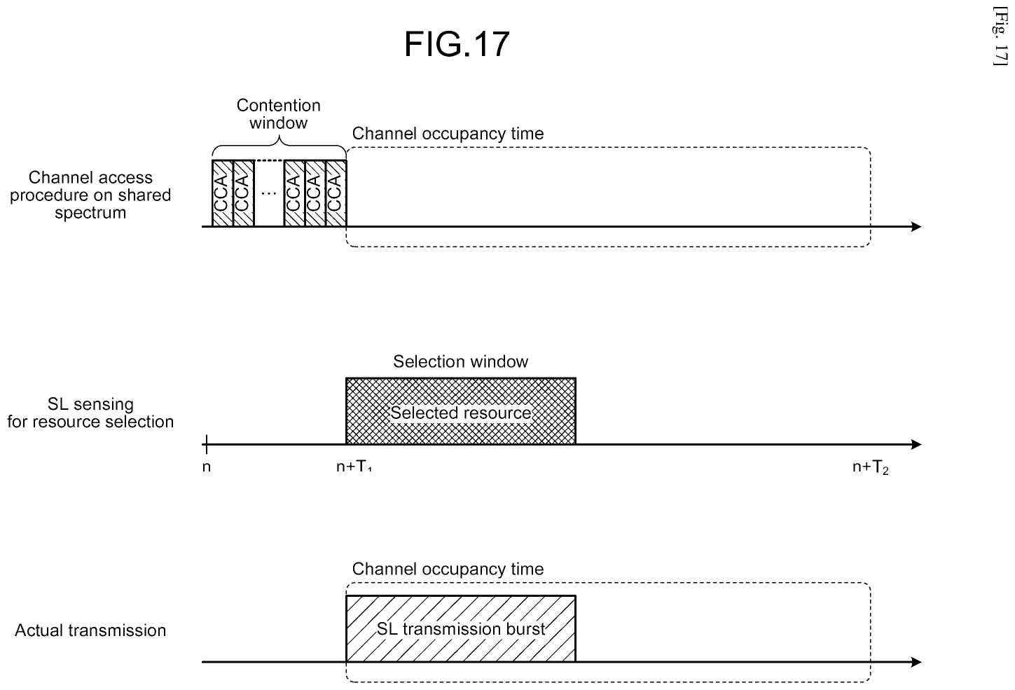

Here, FIG. 17 is a diagram illustrating another example of the second sensing method according to the embodiment of the present disclosure. In FIG. 17, the channel access procedure (LBT) (in the shared channel) for COT acquisition (see the upper diagram), the SL sensing for SL resource selection (see the middle diagram), and actual transmission (see the lower diagram) are illustrated.

In the example of FIG. 17, the TxUE40T determines a time corresponding to the SL transmission burst from the head of the acquired COT as the selection window. In this case, when there is no excluded resource in the selection window, the TxUE40T selects all the selection windows as the SL resources.

In this manner, the TxUE40T may determine a time corresponding to the SL transmission burst from the head of the acquired COT as the selection window.

### Step (D5)]

Details of step (D5) are described.

If the start time point of the COT or the end time point of the CW is not a slot boundary, a dummy signal may be transmitted up to a predetermined slot boundary in which the selected resource can be configured.

If there is an excluded resource in the selection window, the TxUE40T performs one of the following operations. For example, when the selected resource cannot be selected from the start time point of the selection window, the TxUE40T performs any one of the following operations.

Operation Example 1: The TxUE40T does not use the selection window. That is, the TxUE40T continues to execute the second sensing method on other resources until a selection window having no excluded resource appears.

Operation example 2: The TxUE40T determines one or a plurality of SL transmission bursts on a resource other than the excluded resource. The TxUE40T performs any one of the following operations.

Operation Example 2-1: The TxUE40T continues the CCA (is pending) until the start time point of the SL transmission burst.

Operation Example 2-2: The TxUE40T transmits a predetermined burst signal until the start time point of the SL transmission burst. In addition, the burst signal may be transmitted by a resource other than the excluded resource. That is, the burst signal is not transmitted by the excluded resource. Further, the burst signal may be transmitted at a predetermined low transmission power.

Operation Example 2-3: The TxUE40T is pending until the start time point of the SL transmission burst and performs predetermined channel access (for example, Type 2 or the like) in accordance with the start of the SL transmission burst.

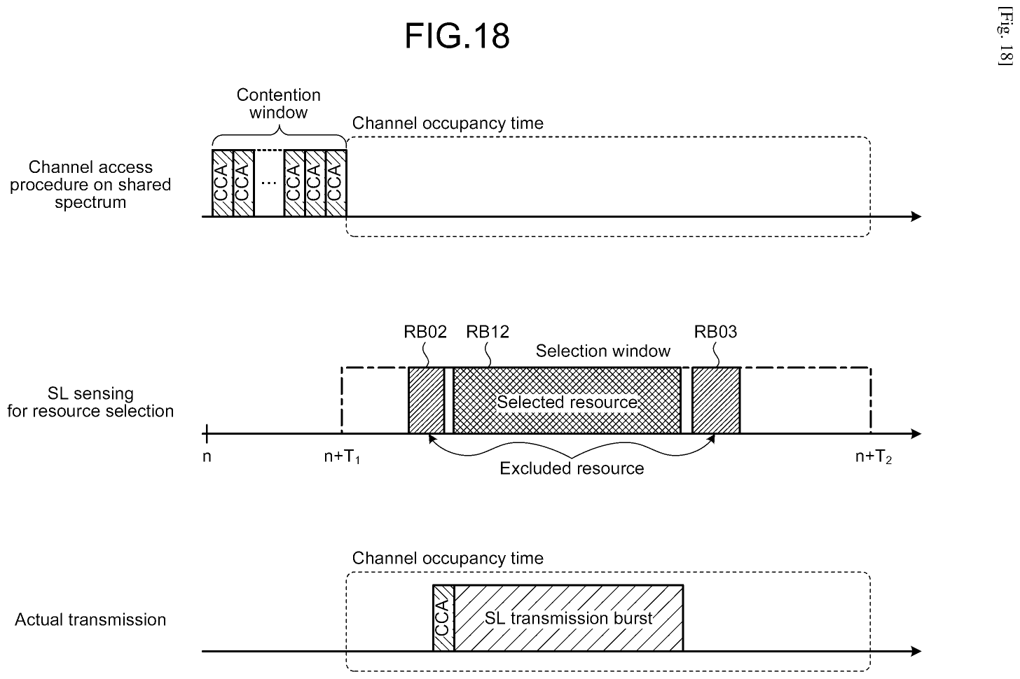

FIG. 18 is a diagram illustrating another example of the second sensing method according to the embodiment of the present disclosure. In FIG. 18, the channel access procedure (LBT) (in the shared channel) for COT acquisition (see the upper diagram), the SL sensing for SL resource selection (see the middle diagram), and actual transmission (see the lower diagram) are illustrated.

In the example illustrated in FIG. 18, the TxUE40T determines the acquired COT as the selection windows (SL resource selection windows) [n+T₁ and n+T₂].

Since there is an excluded resource in the selection window, the TxUE40T executes Operation Example 2 described above and determines one or a plurality of SL transmission bursts by resources other than the excluded resource. In the example of FIG. 18, the TxUE40T sets resources RB02 and RB03 as the excluded resources and sets a resource RB12 as the selected resource.

The TxUE40T transmits SL data in the resource RB12 and performs Operation Example 2-3 at this time. More specifically, as illustrated in FIG. 18, the TxUE40T performs predetermined channel access and starts the SL transmission burst.

### 3.3.3. Details of Third Sensing Method

The TxUE40T executes the following procedure (step) as a third sensing method.

(E1) At the time n (see the middle diagram of FIG. 16), a trigger for the SL resource selection occurs. That is, the SL transmission traffic (SL-SCH) is generated.

(E2) The TxUE40T individually (independently) performs the LBT sensing (channel access procedure) and the SL sensing.

(E3) The TxUE40T determines the SL transmission burst (such as one or a plurality of PSCCH/PSSCH) based on the COT acquired by the LBT sensing and the resource selected based on the SL sensing and performs the SL transmission.

Details of each procedure is described below.

### Step (E2)

First, details of step (E2) are described.

The determination of the parameters (for example, the start timing of the CW and the start timing of the COT) used for the LBT sensing (channel access procedure) may be performed as up to UE implementation of the TxUE40T. Similarly, the determination of the parameters (for example, a selection window) used for the SL sensing may be performed as up to UE implementation of the TxUE40T. In this case, each parameter may be determined similarly to the first sensing method and/or the second sensing method described above.

### Step (E3)]

Details of step (E3) are described.

In the sensing windows, resources not included in the COT (not overlapping) may be excluded resources.

Specifically, the following procedure (step) is added or replaced as one procedure (step) of the SL sensing in the related art described above.

The TxUE40T excludes resources (any candidate single-slot resources R_{x,y}) satisfying all of the following conditions from the set SA.

Slot t′ₘ^{SL} not included in COT acquired by LBT sensing (channel access procedure)

The TxUE40T determines the SL transmission burst by any one of the following methods or a combination of the methods.

### (SL Transmission Burst Determination Method 1)

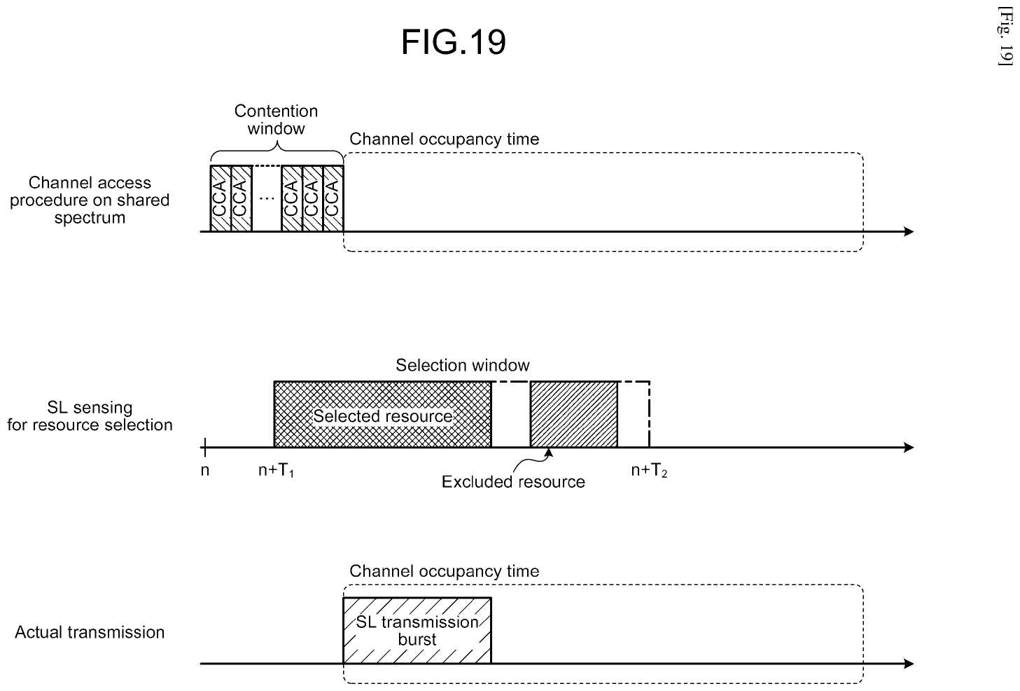

FIG. 19 is a diagram illustrating an example of the third sensing method according to the embodiment of the present disclosure. In FIG. 19, the channel access procedure (LBT) (in the shared channel) for COT acquisition (see the upper diagram), the SL sensing for SL resource selection (see the middle diagram), and actual transmission (see the lower diagram) are illustrated.

As illustrated in FIG. 19, it is assumed that the first timing (slot) of the COT is included in (overlaps with) the selected resource. In this case, at least a part of overlapping (common) resources of the COT and the selected resources is determined as the SL transmission burst.

Alternatively, all the COT may be determined as the SL transmission burst regardless of the length of the selected resource.

### (SL Transmission Burst Determination Method 2)

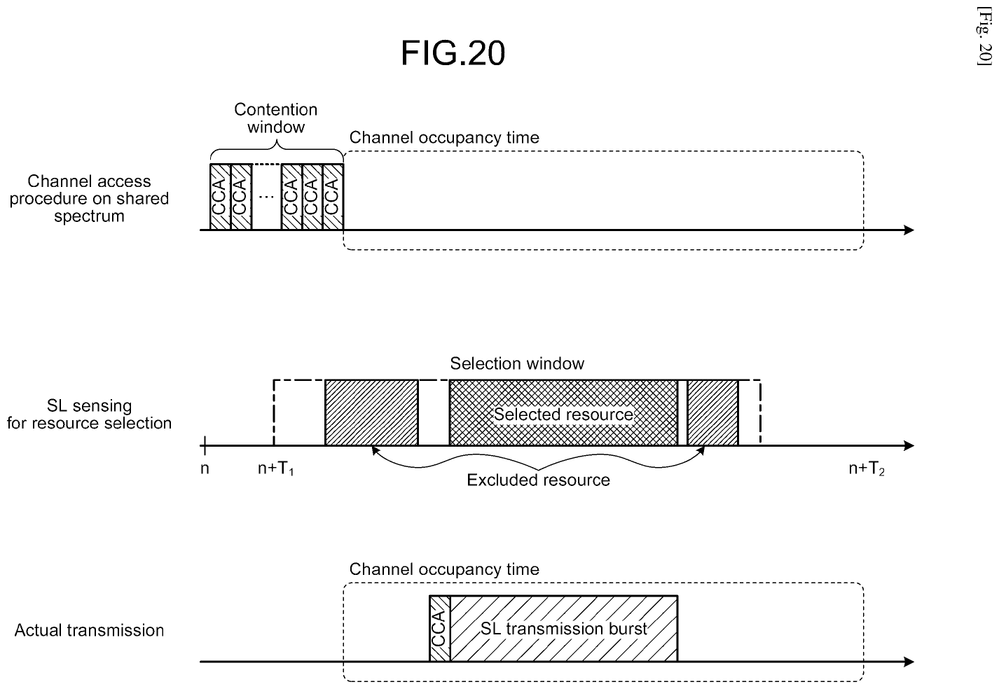

FIG. 20 is a diagram illustrating an example of the third sensing method according to the embodiment of the present disclosure. In FIG. 20, the channel access procedure (LBT) (in the shared channel) for COT acquisition (see the upper diagram), the SL sensing for SL resource selection (see the middle diagram), and actual transmission (see the lower diagram) are illustrated.

As illustrated in FIG. 20, it is assumed that the first timing (slot) of the COT is not included in (does not overlap with) the selected resource. In this case, at least a part of overlapping (common) resources of the COT and the selected resources is determined as the SL transmission burst.

However, as illustrated in FIG. 20, the TxUE40T may perform Type 2A/B/C channel access immediately before the SL transmission burst in the COT. Alternatively, the TxUE40T may continue the CCA (be pending) until the start time point of the SL transmission burst.

Alternatively, when the first timing (slot) of the COT is not included in (does not overlap with) the selected resource, the TxUE40T may not use the COT. In this case, the TxUE40T performs the SL-U sensing method again.

### 3.3.4. Switching of Each Sensing Method

A plurality of SL-U sensing methods (for example, first to third sensing methods) described above are defined and may be selected and used according to predetermined conditions or signaling from the base station 20 or the like. The TxUE40T selects the SL-U sensing method, for example, based on at least one of the control information from the base station 20, information relating to the SL data, and information relating to the LBT sensing.

For example, the SL-U sensing method to be used can be configured to be specific to the UE or common to cells by signaling of PHY, MAC, and RRC layers from the base station 20. More specifically, it is assumed that the SL-U sensing method is notified from the base station 20 by RRC layer signaling. In this case, an IE indicating the SL-U sensing method applied to the TxUE40T may be included in the RRC message and transmitted from the base station 20 to the TxUE40T.

Further or alternatively, it is assumed that the SL-U sensing method is notified from the base station 20 by MAC layer signaling. In this case, a field indicating the SL-U sensing method applied to the TxUE40T may be included in the MAC CE and transmitted from the base station 20 to the TxUE40T.

Further or alternatively, it is assumed that the SL-U sensing method is notified from the base station 20 by PHY layer signaling. In this case, a field indicating the SL-U sensing method applied to the TxUE40T may be included in the DCI and transmitted.

Further or alternatively, the SL-U sensing method may be notified by signaling from at least a plurality of PHY, MAC, and RRC layers from the base station 20. For example, the base station 20 may include the plurality of SL-U sensing methods that may be applied to the TxUE40T as RRC Config (or a list of IEs) in the RRC message and transmit the RRC message to the TxUE40T.

Furthermore, the base station 20 may designate, with the MAC CE or the DCI, information for designating the SL-U sensing method to be applied by the TxUE40T at a certain timing from among the plurality of SL-U sensing methods configured by the RRC.

Furthermore, for example, the SL-U sensing method to be used may be selected implicitly according to the following conditions, statuses, and the like.

### SL Transmission Type (Signal or Channel)

Priority of SL Transmission

### Request Delay of SL Transmission (Remaining Packet Delay Budget)

Channel access procedure type

### (SL Transmission Type)

When the SL-U sensing method is selected according to the type of the SL transmission (signal or channel), any one of the first to third sensing methods described above may be used in the case of the transmission of PSCCH and/or PSSCH.

Further, in the case of the transmission of a synchronization signal and a broadcast channel (sidelink-synchronization signal and PBCH block: SL-SSB), one of the remaining two SL-U sensing methods may be used. That is, in the case of the transmission of the synchronization signal and the broadcast channel, one of the first to third sensing methods that is not selected for the transmission of the PSCCH and/or the PSSCH may be used.

For example, the first sensing method is used in the case of transmission of PSCCH and/or PSSCH, and the second sensing method is used in the case of transmission of the synchronization signal and the broadcast channel. Alternatively, the usage of the methods may be reversed.

As another example, any one of the first to third sensing methods may be used in the case of PSCCH transmission, and one of the remaining two sensing methods may be used in the case of the PSSCH transmission. For example, the first sensing method is used in the case of the PSCCH transmission, and the second sensing method is used in the case of PSSCH transmission. Alternatively, the usage of the methods may be reversed.

As another example, any one of the first to third sensing methods may be used in the case of the transmission of PSCCH and/or PSSCH, and one of the remaining two sensing methods may be used in the case of the PSFCH transmission. For example, the first sensing method is used in the case of the transmission of the PSCCH and/or the PSSCH, and the second sensing method is used in the case of PSFCH transmission. Alternatively, the usage of the methods may be reversed.

### (Priority of SL Transmission)

When the SL-U sensing method is selected according to the priority of the SL transmission, any one of the first to third sensing methods may be used in the SL transmission in which the priority is higher than a predetermined value.

In addition, in the case of the SL transmission in which the priority is lower than a predetermined value, one of the remaining two SL-U sensing methods may be used. That is, in the case of the SL transmission in which the priority is lower than the predetermined value, one of the methods not selected in the SL transmission in which the priority is higher than the predetermined value among the first to third sensing methods may be used.

For example, the second sensing method is used in the case of the SL transmission in which the priority is higher than the predetermined value, and the first sensing method is used in the case of the SL transmission in which the priority is lower than the predetermined value. Alternatively, the usage of the methods may be reversed.

### (Request Delay of SL Transmission)

When the SL-U sensing method is selected according to a request delay (remaining packet delay budget) of the SL transmission, any one of the first to third sensing methods may be used in the SL transmission in which the request delay is smaller than a predetermined value.

Also, in a case of the SL transmission in which the request delay is greater than the predetermined value, one of the remaining two SL-U sensing methods may be used. That is, in the case of the SL transmission in which the request delay is larger than the predetermined value, one of the first to third sensing methods that has not been selected in the SL transmission in which the request delay is smaller than the predetermined value may be used.

For example, the second sensing method is used in the case of the SL transmission in which the request delay is smaller than the predetermined value, and the first sensing method is used in the case of transmission in which the request delay is larger than the predetermined value. Alternatively, the usage of the methods may be reversed.

### (Channel Access Procedure Type)

The SL-U sensing method is selected according to at least one of the channel access procedure type and the category. When the SL-U sensing method is selected according to the channel access procedure type, in the case of the Type 2 or 3 channel access, any one of the first to third sensing methods may be used.

In addition, in the case of Type 1 Channel access, one of the remaining two SL-U sensing methods may be used. That is, in the case of Type 1 channel access, one of the first to third sensing methods that is not selected in the Type 2 or 3 channel access may be used.

For example, the second sensing method is used in the case of the Type 2 or 3 channel access, and the first sensing method is used in the case of the Type 1 channel access. Alternatively, the usage of the methods may be reversed.

### 3.4. SL-U Sensing Method based on CPS

The first and second sensing methods described above may also be applied to the SL-U sensing method based on contiguous partial sensing (CPS). In the CPS, the sensing window may be configured after the time n. The configuration of the sensing window and the like are described below.

### (First Sensing Method)

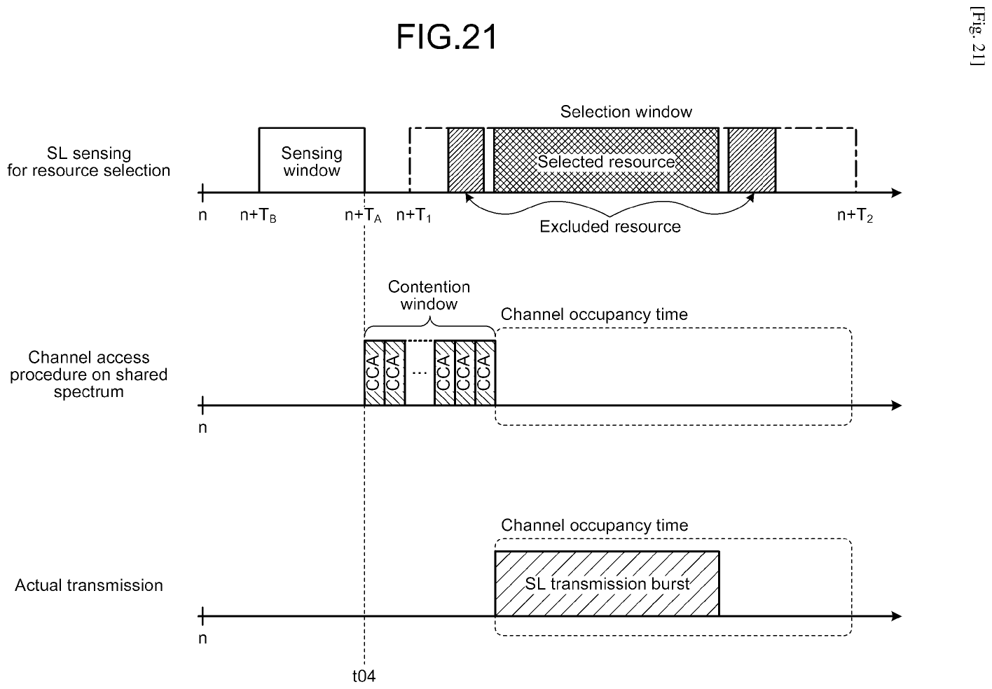

FIG. 21 is a diagram illustrating an example of an SL-U sensing method based on CPS according to the embodiment of the present disclosure. In FIG. 21, the SL sensing for the SL resource selection (see the upper diagram), the channel access procedure (LBT) (in the shared channel) for COT acquisition (see the middle diagram), and the actual transmission (see the lower diagram) are illustrated.

FIG. 21 illustrates a case where the first sensing method is applied to the SL-U sensing method based on the CPS. The sensing window is configured by any of the following methods.

The sensing window is configured, for example, based on the CW. For example, the end time point (T_{A}) of the sensing window is determined based on the start time point of the CW (see a time t04 in FIG. 21). For example, the CW is performed after the sensing window.

### (Second Sensing Method)

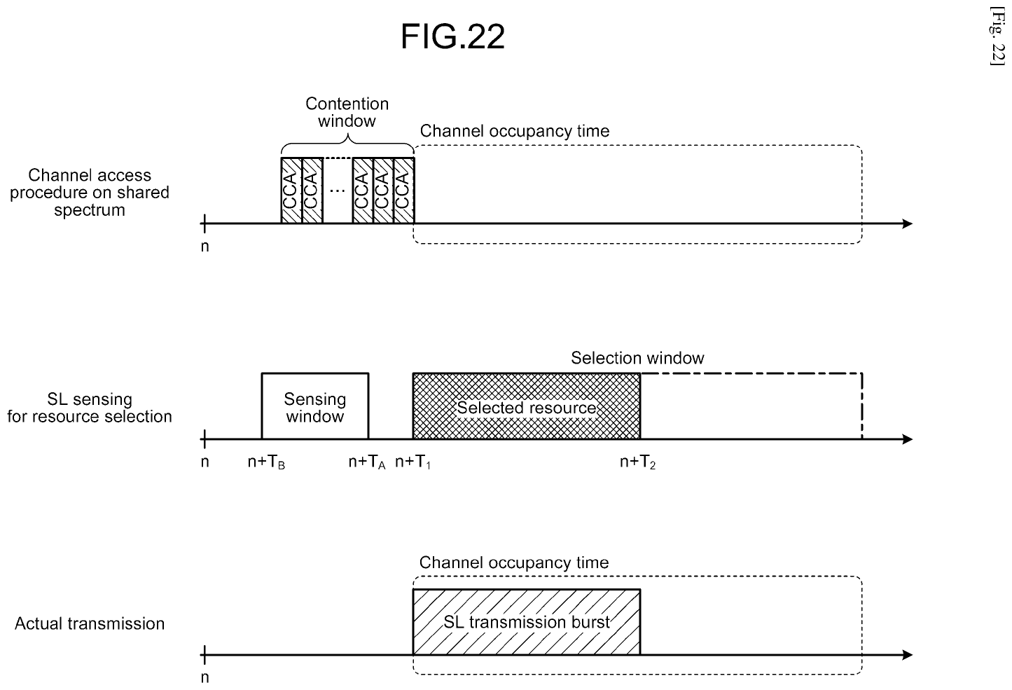

FIG. 22 is a diagram illustrating another example of the SL-U sensing method based on the CPS according to the embodiment of the present disclosure. In FIG. 22, the channel access procedure (LBT) (in the shared channel) for COT acquisition (see the upper diagram), the SL sensing for SL resource selection (see the middle diagram), and actual transmission (see the lower diagram) are illustrated.

FIG. 22 illustrates a case where the second sensing method is applied to the SL-U sensing method based on the CPS. The sensing window is configured by any of the following methods.

The start time point (T_{B}) of the sensing window is determined based on the start time point of the CW and/or the end time point of the CW (the start time point of the COT).

Alternatively, the end time point (T_{A}) of the sensing window is determined based on the start time point of the CW and/or the end time point of the CW (the start time point of the COT).

### (Third Sensing Method)

The third sensing method may be applied to the SL-U sensing method based on the CPS. In this case, the sensing window is configured independently of the CW (without being related to a parameter used to configure the CW). The subsequent operations are similar to the case of the full sensing.

### 3.5. Sharing of COT Acquired by SL-U Sensing

The TxUE40T may share the COT acquired using the SL-U sensing method with another terminal device 40. The COT sharing of the COT acquired by the SL-U sensing is defined as either or both of the first and second COT sharing methods as follows.

Note that the first and second COT sharing methods are different from the COT response mode and the COT sharing mode described above. That is, the TxUE40T may execute at least one of the first and second COT sharing methods in a state where the COT response mode and/or the COT sharing mode described above are configured.

### 3.5.1. First COT Sharing Method

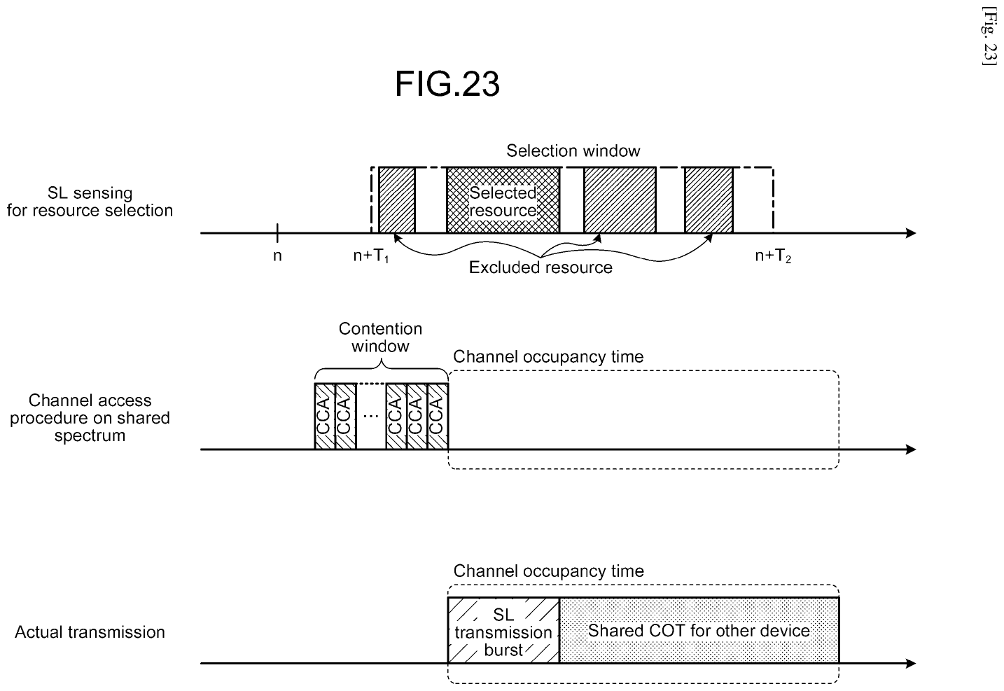

FIG. 23 is a diagram illustrating an example of a first COT sharing method according to the embodiment of the present disclosure. FIG. 23 illustrates a first COT sharing method when the TxUE40T acquires the COT by the first sensing method illustrated in FIG. 15.

The TxUE40T performs SL transmission burst using at least a part of the acquired COT. More specifically, the TxUE40T performs SL transmission burst on the selected resources in the selection window.

The TxUE40T may share a resource other than the SL transmission burst in the acquired COT with another device (another terminal device 40). At this time, as illustrated in FIG. 23, the TxUE40T may share the COT including the excluded resource. Furthermore, at this time, as illustrated in FIG. 23, the TxUE40T may share the COT including resources outside the selection window.

Alternatively, the TxUE40T may exclude the excluded resource and share the COT. Furthermore, the TxUE40T may share the COT while being limited within the selection window.

Note that, in FIG. 23, the TxUE40T performs the SL transmission burst on all the selected resources but the TxUE40T may perform the SL transmission burst on a part of the selected resources. In this case, the TxUE40T may perform COT sharing on the rest of the selected resources that are not used in the SL transmission burst with the other terminal devices 40.

Furthermore, here, a case where the TxUE40T shares the COT acquired based on the first sensing method is described. With respect to the COT acquired based on another sensing method (for example, the second and third sensing methods), the TxUE40T may similarly share the COT with another terminal device 40 by the first COT sharing method.

### 3.5.2. Second COT Sharing Method

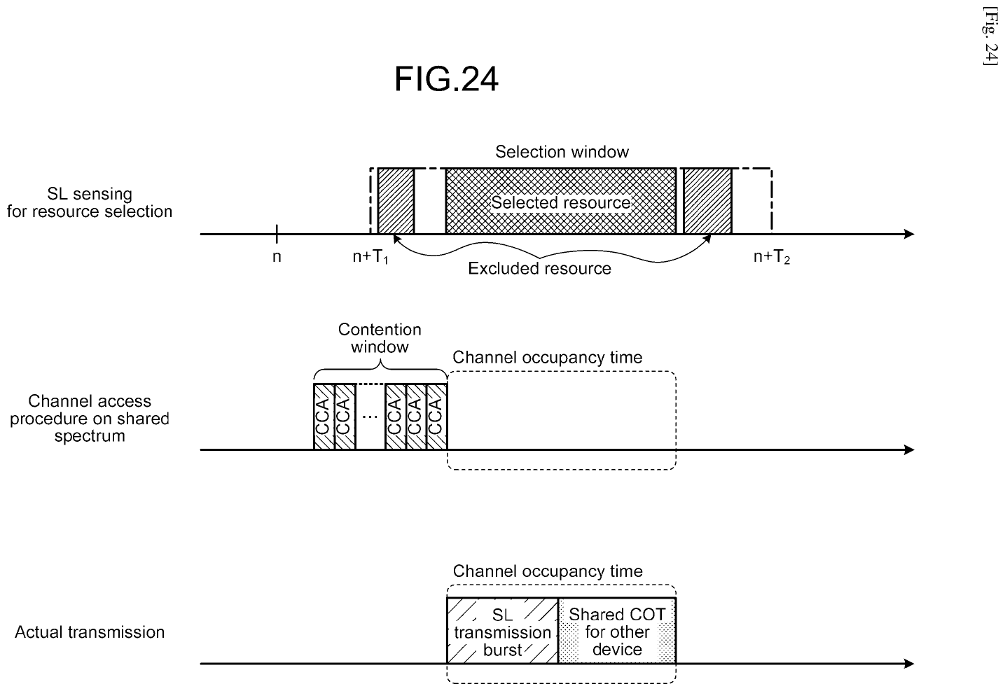

FIG. 24 is a diagram illustrating an example of a second COT sharing method according to the embodiment of the present disclosure. FIG. 24 illustrates the second COT sharing method when the TxUE40T acquires the COT by the first sensing method. In FIG. 24, the SL sensing for the SL resource selection (see the upper diagram), the channel access procedure (LBT) (in the shared channel) for the COT acquisition (see the middle diagram), and the actual transmission (see the lower diagram) are illustrated.

In the example of FIG. 24, the TxUE40T acquires the COT with the same time length as the selected resource. The TxUE40T performs the SL transmission burst on a part of the selected resources.

The TxUE40T performs COT sharing on the rest of the selected resources that are not used in the SL transmission burst with another devices (another terminal device 40). That is, the selected resources include both the SL transmission burst and the shared COT. In other words, in the COT sharing, the resources other than the selected resources are not shared with the other terminal devices 40.

Note that, in FIG. 24, the COT acquired by the TxUE40T is the same as the selected resource, but the acquired COT may be longer than the selected resource. That is, the end time point of the COT may be after the end time point of the selected resource. In addition, the end time point of the COT may be after the end time point (n+T₂) of the selection window.

Also in this case, the TxUE40T performs COT sharing on the rest of the selected resources that are not used in the SL transmission burst with the other terminal devices 40. That is, the COT that is not included in the selected resources is not shared with the other terminal devices 40.

Furthermore, here, a case where the TxUE40T shares the COT acquired based on the first sensing method is described. With respect to the COT acquired based on another sensing method (for example, the second and third sensing methods), the TxUE40T may similarly share the COT with another terminal device 40 by the second COT sharing method.

### 3.6. Sensing Method in Sidelink Resource Allocation Mode 1

In Sidelink Resource Allocation Mode 1, the base station 20 allocates sidelink transmission resources to the TxUE40T. The sidelink transmission resource is allocated by a method of dynamically allocating the sidelink transmission resources by downlink control information (DCI and sidelink grant) transmitted through the PDCCH or a method of semi-statically allocating the sidelink transmission resources by RRC signaling.

In the licensed band, the TxUE40T can perform sidelink transmission by using the allocated transmission resources. However, in the unlicensed band, the TxUE40T needs to perform the LBT sensing before the allocated transmission resource. Therefore, as a result of the LBT sensing, there may be a case where the TxUE40T cannot perform sidelink transmission by using the allocated transmission resources.

In Sidelink Resource Allocation Mode 1, the TxUE40T may perform LBT sensing and may not perform sidelink sensing. Alternatively, the TxUE40T may perform both the LBT sensing and the sidelink sensing similarly to the sensing method described above.

### 3.6.1. Operation when Transmission cannot be performed by LBT Sensing

As a result of the LBT sensing performed by the TxUE40T, it is assumed that sidelink transmission cannot be performed by using the allocated transmission resources. In that case, the TxUE40T transmits, to the base station 20, information indicating that the transmission cannot be performed by using the allocated transmission resource or information generated based on the fact that the transmission cannot be performed. This information (hereinafter, it is also described as non-transmission information) is transmitted through the PUCCH or the PUSCH.

Further, a method similar to the HARQ-ACK report can be used for the non-transmission information. For example, the TxUE40T notifies the base station 20 of information indicating Nack for the sidelink grant.

Therefore, as a result of the LBT sensing, it is assumed that the TxUE40T can perform sidelink transmission by using the allocated transmission resources. In this case, the TxUE40T may notify the base station 20 of information indicating the Ack for the sidelink grant or may notify nothing.

Further, for the non-transmission information, a method similar to the method for transmitting a request for allocating a sidelink transmission resource (scheduling request (SR)) can be used. For example, the TxUE40T notifies the base station 20 of information indicating that the transmission cannot be performed by using the allocated transmission resource simultaneously with the SR. Note that different PUCCH resources may be configured to distinguish from normal SR.

### 3.6.2. Sidelink Transmission Resource Allocated in Sidelink Resource Allocation Mode 1

In Sidelink Resource Allocation Mode 1, the TxUE40T is notified of a resource that enables sidelink transmission from the base station 20. That is, in the licensed band, the base station 20 notifies the transmission resource on which the TxUE40T performs sidelink transmission. However, in the unlicensed band, the base station 20 may notify resources that the TxUE40T can use for sidelink transmission (hereinafter, also referred to as sidelink transmittable resources). Note that the sidelink transmittable resource may be a resource wider than the transmission resource notified by the base station 20 in the licensed band in the frequency domain and/or the time domain. Further, the sidelink transmittable resource can be regarded as a resource pool dynamically allocated by using the PDCCH.

The TxUE40T determines a transmission resource from among the notified sidelink transmittable resources by a predetermined sensing method and transmits the transmission resource. The predetermined sensing method includes LBT sensing, sidelink sensing, or the sensing method described above. In other words, the TxUE40T selects a transmission resource from the resource pool allocated from the base station 20 by using the PDCCH by a predetermined sensing method and performs sidelink transmission. Accordingly, the probability that the TxUE40T cannot perform sidelink transmission can be reduced according to the result of the LBT sensing. Note that the method may be newly defined as a mode (for example, Sidelink Resource Allocation Mode 3) different from Sidelink Resource Allocation Mode 1 or 2.

### 4. Other Embodiments

The embodiments described above are examples, and various modifications and ap-plications are possible.

For example, the control device that controls the base station 20 and the terminal device 40 according to the embodiments described above may be realized by a dedicated computer system or may be realized by a general-purpose computer system.

For example, a communication program for performing the operation described above is stored and distributed in a computer-readable recording medium such as an optical disk, a semiconductor memory, a magnetic tape, or a flexible disk. Then, the control device is configured, for example, by installing the corresponding program in a computer and executing the processing described above. At this time, the control device may be a device (for example, a personal computer) outside the base station 20 and the terminal device 40. Furthermore, the control device may be a device (for example, the control units 24 and 45) inside the base station 20 and the terminal device 40.

In addition, the communication program may be stored in a disk device included in a server device on a network such as the Internet to be downloaded to a computer. In addition, the functions described above may be realized in cooperation with an operating system (OS) and application software. In this case, a part other than the OS may be stored in a medium and distributed, or a part other than the OS may be stored in a server device and downloaded to a computer.

Among the processes described in the above embodiments, all or a part of the processes described as being performed automatically can be performed manually, or all or a part of the processes described as being performed manually can be performed automatically by a known method. In addition, the processing procedure, specific names, and information including various data and parameters disclosed in the document and the drawings can be arbitrarily changed unless otherwise specified. For example, the various types of information illustrated in each figure are not limited to the illustrated information.

In addition, each component of each device illustrated in the drawings is functionally conceptual and is not necessarily physically configured as illustrated in the drawings. That is, a specific form of distribution and integration of each device is not limited to the illustrated form, and all or a part thereof can be configured to be functionally or physically distributed and integrated in an arbitrary unit according to various loads, usage statuses, and the like. Note that this configuration by distribution and integration may be performed dynamically.

In addition, the embodiments described above can be appropriately combined in a region in which the processing contents do not contradict each other. Furthermore, the order of each step illustrated in the sequence diagram according to the embodiment described above can be changed as appropriate.

Furthermore, for example, the present embodiment can be implemented as any configuration constituting a device or a system, for example, a processor as a system large scale integration (LSI) or the like, a module using a plurality of processors or the like, a unit using a plurality of modules or the like, a set obtained by further adding other functions to a unit, or the like (that is, a configuration of a part of the device).

Note that, in the present embodiment, the system means a set of a plurality of components (such as devices or modules (parts)), and it does not matter whether all the components are in the same housing. Therefore, a plurality of devices that are stored in separate housings and connected via a network and one device in which a plurality of modules are stored in one housing are both systems.

Furthermore, for example, the present embodiment can adopt a configuration of cloud computing in which one function is shared and processed by a plurality of devices in cooperation via a network.

### 5. Conclusion

Although the embodiments of the present disclosure have been described above, the technical scope of the present disclosure is not limited to the embodiments described above as it is, and various modifications can be made without departing from the gist of the present disclosure. In addition, components of different embodiments and modifications may be appropriately combined.

Furthermore, the effects of each embodiment described in the present specification are merely examples and are not limited, and other effects may be provided.

Note that the present technology can also have the following configurations.

(1)

A terminal device comprising:
a communication unit that performs sidelink communication with another terminal device on a shared spectrum; and
a control unit that performs sidelink sensing relating to the sidelink communication and listen before talk (LBT) sensing relating to communication in the shared spectrum via the communication unit,
selects a transmission resource for sidelink communication with the another terminal device by using any one of a first method, a second method, and a third method, and
transmits one or more items of sidelink data by using the selected transmission resource via the communication unit,
wherein the first method is a method of selecting the transmission resource by performing the LBT sensing based on a result of the sidelink sensing,
the second method is a method of selecting the transmission resource by performing the sidelink sensing based on a result of the LBT sensing, and
the third method is a method of selecting the transmission resource by individually performing the sidelink sensing and the LBT sensing.
   (2)

The terminal device according to (1), wherein, as the first method, the control unit
selects a sidelink sensing resource from a predetermined sidelink resource selection window based on the result of the sidelink sensing,
acquires a channel occupancy time (COT) by performing the LBT sensing based on the sidelink sensing resource, and
selects the transmission resource based on the COT and the sidelink sensing resource.
   (3)

The terminal device according to (2), wherein the sidelink resource selection window is determined based on at least one of a time length necessary for transmission of the sidelink data, a time length of the COT that may be acquired by the LBT sensing, a size of a contention window in the LBT sensing, and a channel access type in the LBT sensing.

(4)

The terminal device according to (2) or (3), wherein, when the sidelink sensing resource having a time length necessary for transmission of the sidelink data is not selected from the sidelink resource selection window, the control unit changes a parameter relating to the sidelink sensing and performs the sidelink sensing again to select the sidelink sensing resource.

(5)

The terminal device according to any one of (2) to (4), wherein the LBT sensing is performed such that an end time point of a contention window or a start time point of the COT becomes a start time point of the sidelink sensing resource.

(6)

The terminal device according to any one of (2) to (5), wherein, as a result of the LBT sensing, when an end time point of a contention window or a start time point of the COT is the same as a start time point of the sidelink sensing resource or before a start time point of the sidelink sensing resource, the control unit selects the sidelink sensing resource as the transmission resource.

(7)

The terminal device according to any one of (2) to (6), wherein, as a result of the LBT sensing, when an end time point of a contention window or a start time point of the COT is later than a start time point of the sidelink sensing resource, the control unit performs a predetermined process defined or configured in advance.

(8)

The terminal device according to (7), in which the predetermined process includes any one of a first process of performing reselection of the transmission resource, a second process of canceling transmission of the sidelink data, a third process of selecting the transmission resource from resources from a time point when the COT is acquired to an end time point of the sidelink sensing resource, and a fourth process of selecting the transmission resource from resources from a time point when the COT is acquired to a time length same as a time length of the sidelink sensing resource.

(9)

The terminal device according to any one of (1) to (8), wherein, as the second method, the control unit
selects a sidelink sensing resource from a predetermined sidelink resource selection window based on the result of the sidelink sensing, acquires a COT by performing the LBT sensing based on the sidelink sensing resource, and selects the transmission resource based on the COT and the sidelink sensing resource.
   (10)

The terminal device according to (9), wherein, when the sidelink sensing resource can be selected from a start time point of the sidelink resource selection window, the transmission resource is the sidelink sensing resource selected from the start time point of the sidelink resource selection window.

(11)

The terminal device according to (9) or (10), wherein, when the sidelink sensing resource cannot be selected from a start time point of the sidelink resource selection window, the control unit performs a predetermined process defined or configured in advance.

(12)

The terminal device according to (11), in which the predetermined process includes any one of a fifth process of performing reselection of the transmission resource, a sixth process of canceling transmission of the sidelink data, and a seventh process of selecting one or a plurality of the transmission resources from the sidelink resource selection window.

(13)

The terminal device according to (12), in which in a case of executing the seventh process, the control unit executes any one of an eighth process of continuing the LBT sensing until a start time point of the transmission resource, a ninth process of transmitting a burst signal until the start time point of the transmission resource, and a tenth process of performing the predetermined LBT sensing according to a start time point of the transmission resource.

(14)

The terminal device according to any one of (8) to (13), wherein a start time point of the sidelink resource selection window is determined to be the same as a start time point of the COT or an end time point of a contention window or to be after the start time point of the COT or the end time point of the contention window.

(15)

The terminal device according to any one of (1) to (14), wherein, as the third method, the control unit selects at least a part of resources in which a COT acquired by the LBT sensing and a sidelink sensing resource selected based on the sidelink sensing overlap each other as the transmission resources.

(16)

The terminal device according to any one of (1) to (15), wherein the control unit determines any one of the first method, the second method, and the third method based on at least one of control information from a base station, information relating to the sidelink data, and information relating to the LBT sensing.

(17)

The terminal device according to (16), in which the information relating to the sidelink data includes at least one of a type of the sidelink data, priority information, and a required delay time.

(18)

The terminal device according to (16) or (17), in which the information relating to the LBT sensing includes at least one of a channel access procedure type and a category of the LBT sensing.

(19)

The terminal device according to any one of (1) to (18), wherein a resource other than the transmission resource in the COT acquired by the terminal device by the LBT sensing may be shared with other terminal devices including the another terminal device.

(20)

The terminal device according to (19), wherein the resource that may be shared with the another terminal device is a part of a sidelink sensing resource selected by the sidelink sensing.

(21)

A communication method comprising:
performing sidelink communication with another terminal device on a shared spectrum;
performing sidelink sensing relating to the sidelink communication and LBT sensing relating to communication in the shared spectrum;
selecting a transmission resource for sidelink communication with the another terminal device by using any one of a first method, a second method, and a third method; and
transmitting one or more items of sidelink data by using the selected transmission resource,
wherein the first method is a method of selecting the transmission resource by performing the LBT sensing based on a result of the sidelink sensing,
the second method is a method of selecting the transmission resource by performing the sidelink sensing based on a result of the LBT sensing, and
the third method is a method of selecting the transmission resource by individually performing the sidelink sensing and the LBT sensing.

### (1A)

A terminal device comprising:
a transceiver configured to perform sidelink communication with another terminal device in a shared spectrum, the shared spectrum being a radio frequency spectrum; and
circuitry configured to
   select a transmission resource in the shared spectrum for sidelink communication with the another terminal device by using any one of a first channel allocation protocol, a second channel allocation protocol, or a third channel allocation protocol, and
   transmit, via the transceiver, one or more items of sidelink data in the shared spectrum by using the selected transmission resource, wherein
the first channel allocation protocol performs Listen Before Talk (LBT) sensing in the shared spectrum based on a result of earlier performed sidelink sensing relating to the sidelink communication in the shared spectrum,
the second channel allocation protocol performs sidelink sensing in the shared spectrum based on a result of earlier performed LBT sensing, and
the third channel allocation protocol performs sidelink sensing and LBT sensing in the shared spectrum independent of one another.

### (2A)

The terminal device according to (1A), wherein
the first channel allocation protocol includes
   selection of a sidelink sensing resource from a predetermined sidelink resource selection window based on the result of the earlier performed sidelink sensing,
   acquisition of a channel occupancy time (COT) by the LBT sensing based on the selected sidelink sensing resource, and
   selection of the transmission resource based on the COT and the selected sidelink sensing resource.

### (3A)

The terminal device according to (2A), wherein the sidelink resource selection window is determined based on at least one of a time length necessary for transmission of the sidelink data, a time length of the COT acquired by the LBT sensing, a size of a contention window in the LBT sensing, and a channel access type in the LBT sensing.

### (4A)

The terminal device according to (2A), wherein, under a condition the sidelink sensing resource having a time length necessary for transmission of the sidelink data is not selected from the sidelink resource selection window, the circuitry is configured to change a parameter relating to the sidelink sensing and repeat sidelink sensing to select the sidelink sensing resource.

### (5A)

The terminal device according to (2A), wherein as an aspect of the LBT sensing, an end time point of a contention window or a start time point of the COT becomes a start time point of the sidelink sensing resource.

### (6A)

The terminal device according to (2A), wherein, as a consequence of the result of the LBT sensing, under a condition an end time point of a contention window or a start time point of the COT is the same as a start time point of the sidelink sensing resource or before a start time point of the sidelink sensing resource, the circuitry is configured to select the sidelink sensing resource as the transmission resource.

### (7A)

The terminal device according to (2A), wherein, as a consequence of the result of the LBT sensing, under a condition an end time point of a contention window or a start time point of the COT is later than a start time point of the sidelink sensing resource, the circuitry is configured to perform a predetermined process defined or configured in advance.

### (8A)

The terminal device according to (1A), wherein, the second channel allocation protocol includes
acquisition of a channel occupancy time (COT) by performance of the LBT sensing in a predetermined period,
determination of the acquired COT as a sidelink selection window, and
selection of the transmission resource from the determined sidelink resource selection window based on the result of the earlier performed sidelink sensing.

### (9A)

The terminal device according to (8A), wherein, under a condition the sidelink sensing resource is selectable from a start time point of the sidelink resource selection window in a case the sidelink resource selection window has no excluded resources, the transmission resource is selected from the start time point of the sidelink resource selection window.

### (10A)

The terminal device according to (8A), wherein, under a condition the sidelink sensing resource cannot be selected from a start time point of the sidelink resource selection window in a case the sidelink resource selection window has excluded resources, the circuitry is configured to perform a predetermined process defined or configured in advance.

### (11A)

The terminal device according to (8A), wherein a start time point of the sidelink resource selection window is determined to be the same as a start time point of the COT or an end time point of a contention window, or to be after the start time point of the COT or the end time point of the contention window.

### (12A)

The terminal device according to (1A),
wherein, as an aspect of the third channel allocation protocol, the circuitry is configured to select at least a portion of resources in which a channel occupancy time (COT) acquired by the earlier performed LBT sensing and a sidelink sensing resource selected based on the sidelink sensing overlap each other as the transmission resource.

### (13A)

The terminal device according to (1A), wherein the circuitry is further configured to determine, as a protocol to select the transmission resource, any one of the first channel allocation protocol, the second channel allocation protocol, or the third channel allocation protocol based on at least one of control information from a base station, information relating to the sidelink data, and information relating to the LBT sensing.

### (14A)

The terminal device according to (1A), wherein a resource other than the transmission resource in a channel occupancy time (COT) acquired by the terminal device by the earlier performed LBT sensing may be shared with other terminal devices including the another terminal device.

### (15A)

The terminal device according to (14A), wherein the resource other than the transmission resource is a resource that is sharable with the another terminal device that is a part of a sidelink sensing resource selected by the earlier performed sidelink sensing.

### (16A)

A communication method comprising:
performing sidelink communication with another terminal device in a shared spectrum, the shared spectrum being a radio frequency spectrum;
selecting a transmission resource for sidelink communication in the shared spectrum with the another terminal device by using any one of a first method, a second method, and a third method; and
transmitting one or more items of sidelink data by using the selected transmission resource,
wherein the first method selects the transmission resource by performing Listen Before Talk (LBT) sensing relating to communication in the shared spectrum, the LBT sensing being performed based on a result of the sidelink sensing relating to the sidelink communication,
the second method selects the transmission resource by performing the sidelink sensing in the shared spectrum based on a result of the LBT sensing, and
the third method selects the transmission resource by performing the sidelink sensing in the shared spectrum independent of the LBT sensing.

### (17A)

The method according to (16A), wherein
the first method includes
   selecting a sidelink sensing resource from a predetermined sidelink resource selection window based on the result of the sidelink sensing,
   acquiring a channel occupancy time (COT) by the LBT sensing based on the selected sidelink sensing resource, and
   selecting of the transmission resource based on the COT and the selected sidelink sensing resource.

### (18A)

The method according to (16A), wherein
the second method includes
   acquiring a channel occupancy time (COT) by the LBT sensing in a predetermined period,
   determining the acquired COT as a sidelink selection window, and
   selecting the transmission resource from the determined sidelink resource selection window based on the result of the sidelink sensing.

### (19A)

A non-transitory storage device having stored therein computer readable instructions that upon execution by circuitry configure the circuitry to perform a communication method, the communication method comprising:
performing sidelink communication with another terminal device on a shared spectrum, the shared spectrum being a radio frequency spectrum;
selecting a transmission resource for sidelink communication in the shared spectrum with the another terminal device by using any one of a first method, a second method, and a third method; and
transmitting one or more items of sidelink data by using the selected transmission resource,
wherein the first method selects the transmission resource by performing Listen Before Talk (LBT) sensing relating to communication in the shared spectrum, the LBT sensing being performed based on a result of the sidelink sensing relating to the sidelink communication,
the second method selects the transmission resource by performing the sidelink sensing in the shared spectrum based on a result of the LBT sensing, and
the third method selects the transmission resource by performing the sidelink sensing in the shared spectrum independent of the LBT sensing.

### (20A)

The non-transitory storage device of (19A), wherein the first method further comprising:
selecting a sidelink sensing resource from a predetermined sidelink resource selection window based on the result of the sidelink sensing,
acquiring a channel occupancy time (COT) by the LBT sensing based on the selected sidelink sensing resource, and
selecting of the transmission resource based on the COT and the selected sidelink sensing resource.

### REFERENCE SIGNS LIST

10 Communication device
20 Base station
21, 41 Signal processing unit
22, 42 Storage unit
23 Network communication unit
24, 45 Control unit
40 Terminal device
44 Input/output unit

1. A terminal device comprising:
a transceiver configured to perform sidelink communication with another terminal device in a shared spectrum, the shared spectrum being a radio frequency spectrum; and
circuitry configured to
select a transmission resource in the shared spectrum for sidelink communication with the another terminal device by using any one of a first channel allocation protocol, a second channel allocation protocol, or a third channel allocation protocol, and
transmit, via the transceiver, one or more items of sidelink data in the shared spectrum by using the selected transmission resource, wherein
the first channel allocation protocol performs Listen Before Talk (LBT) sensing in the shared spectrum based on a result of earlier performed sidelink sensing relating to the sidelink communication in the shared spectrum,
the second channel allocation protocol performs sidelink sensing in the shared spectrum based on a result of earlier performed LBT sensing in the shared spectrum, and
the third channel allocation protocol performs sidelink sensing and LBT sensing in the shared spectrum independent of one another.

2. The terminal device according to claim 1, wherein
the first channel allocation protocol includes
selection of a sidelink sensing resource from a predetermined sidelink resource selection window based on the result of the earlier performed sidelink sensing,
acquisition of a channel occupancy time (COT) by the LBT sensing based on the selected sidelink sensing resource, and
selection of the transmission resource based on the COT and the selected sidelink sensing resource.

3. The terminal device according to claim 2, wherein the sidelink resource selection window is determined based on at least one of a time length necessary for transmission of the sidelink data, a time length of the COT acquired by the LBT sensing, a size of a contention window in the LBT sensing, and a channel access type in the LBT sensing.

4. The terminal device according to claim 2, wherein, under a condition the sidelink sensing resource having a time length necessary for transmission of the sidelink data is not selected from the sidelink resource selection window, the circuitry is configured to change a parameter relating to the sidelink sensing and repeat sidelink sensing to select the sidelink sensing resource.

5. The terminal device according to claim 2, wherein as an aspect of the LBT sensing, an end time point of a contention window or a start time point of the COT becomes a start time point of the sidelink sensing resource.

6. The terminal device according to claim 2, wherein, as a consequence of the result of the LBT sensing, under a condition an end time point of a contention window or a start time point of the COT is the same as a start time point of the sidelink sensing resource or before a start time point of the sidelink sensing resource, the circuitry is configured to select the sidelink sensing resource as the transmission resource.

7. The terminal device according to claim 2, wherein, as a consequence of the result of the LBT sensing, under a condition an end time point of a contention window or a start time point of the COT is later than a start time point of the sidelink sensing resource, the circuitry is configured to perform a predetermined process defined or configured in advance.

8. The terminal device according to claim 1, wherein, the second channel allocation protocol includes
acquisition of a channel occupancy time (COT) by performance of the LBT sensing in a predetermined period,
determination of the acquired COT as a sidelink selection window, and
selection of the transmission resource from the determined sidelink resource selection window based on the result of the earlier performed sidelink sensing.

9. The terminal device according to claim 8, wherein, under a condition the sidelink sensing resource is selectable from a start time point of the sidelink resource selection window in a case the sidelink resource selection window has no excluded resources, the transmission resource is selected from the start time point of the sidelink resource selection window.

10. The terminal device according to claim 8, wherein, under a condition the sidelink sensing resource cannot be selected from a start time point of the sidelink resource selection window in a case the sidelink resource selection window has excluded resources, the circuitry is configured to perform a predetermined process defined or configured in advance.

11. The terminal device according to claim 8, wherein a start time point of the sidelink resource selection window is determined to be the same as a start time point of the COT or an end time point of a contention window, or to be after the start time point of the COT or the end time point of the contention window.

12. The terminal device according to claim 1,
wherein, as an aspect of the third channel allocation protocol, the circuitry is configured to select at least a portion of resources in which a channel occupancy time (COT) acquired by the earlier performed LBT sensing and a sidelink sensing resource selected based on the sidelink sensing overlap each other as the transmission resource.

13. The terminal device according to claim 1, wherein the circuitry is further configured to determine, as a protocol to select the transmission resource, any one of the first channel allocation protocol, the second channel allocation protocol, or the third channel allocation protocol based on at least one of control information from a base station, information relating to the sidelink data, and information relating to the LBT sensing.

14. The terminal device according to claim 1, wherein a resource other than the transmission resource in a channel occupancy time (COT) acquired by the terminal device by the earlier performed LBT sensing may be shared with other terminal devices including the another terminal device.

15. The terminal device according to claim 14, wherein the resource other than the transmission resource is a resource that is sharable with the another terminal device that is a part of a sidelink sensing resource selected by the earlier performed sidelink sensing.

16. A communication method comprising:
performing sidelink communication with another terminal device in a shared spectrum, the shared spectrum being a radio frequency spectrum;
selecting a transmission resource for sidelink communication in the shared spectrum with the another terminal device by using any one of a first method, a second method, and a third method; and
transmitting one or more items of sidelink data by using the selected transmission resource,
wherein the first method selects the transmission resource by performing Listen Before Talk (LBT) sensing relating to communication in the shared spectrum, the LBT sensing being performed based on a result of the sidelink sensing relating to the sidelink communication,
the second method selects the transmission resource by performing the sidelink sensing in the shared spectrum based on a result of the LBT sensing, and
the third method selects the transmission resource by performing the sidelink sensing in the shared spectrum independent of the LBT sensing.

17. The method according to claim 16, wherein
the first method includes
selecting a sidelink sensing resource from a predetermined sidelink resource selection window based on the result of the sidelink sensing,
acquiring a channel occupancy time (COT) by the LBT sensing based on the selected sidelink sensing resource, and
selecting of the transmission resource based on the COT and the selected sidelink sensing resource.

18. The method according to claim 16, wherein
the second method includes
acquiring a channel occupancy time (COT) by the LBT sensing in a predetermined period,
determining the acquired COT as a sidelink selection window, and
selecting the transmission resource from the determined sidelink resource selection window based on the result of the sidelink sensing.

19. A non-transitory storage device having stored therein computer readable instructions that upon execution by circuitry configure the circuitry to perform a communication method, the communication method comprising:
performing sidelink communication with another terminal device on a shared spectrum, the shared spectrum being a radio frequency spectrum;
selecting a transmission resource for sidelink communication in the shared spectrum with the another terminal device by using any one of a first method, a second method, and a third method; and
transmitting one or more items of sidelink data by using the selected transmission resource,
wherein the first method selects the transmission resource by performing Listen Before Talk (LBT) sensing relating to communication in the shared spectrum, the LBT sensing being performed based on a result of the sidelink sensing relating to the sidelink communication,
the second method selects the transmission resource by performing the sidelink sensing in the shared spectrum based on a result of the LBT sensing, and
the third method selects the transmission resource by performing the sidelink sensing in the shared spectrum independent of the LBT sensing.

20. The non-transitory storage device of claim 19, wherein the first method further comprising:
selecting a sidelink sensing resource from a predetermined sidelink resource selection window based on the result of the sidelink sensing,
acquiring a channel occupancy time (COT) by the LBT sensing based on the selected sidelink sensing resource, and
selecting of the transmission resource based on the COT and the selected sidelink sensing resource.
